(19) United States
(12) Patent Application Publication
(10) Pub. No.: US 2018/0160332 A1
(43) Pub. Date: Jun. 7, 2018

(54) METHODS, APPARATUSES, COMPUTER READABLE MEDIUM AND COMPUTER PROGRAM PRODUCT FOR CONTROLLING THE DOWNLOAD OF DATA FROM A WIRELESS NETWORK TO A USER EQUIPMENT

(71) Applicant: NOKIA SOLUTIONS AND NETWORKS OY, Espoo (FI)

(72) Inventor: John HARRIS, Whitefish Bay, WI (US)

(21) Appl. No.: 15/737,081

(22) PCT Filed: Jun. 15, 2016
(86) PCT No.: PCT/EP2016/063761

§ 371 Date: Dec. 15, 2017

Related U.S. Application Data
(60) Provisional application No. 62/175,676, filed on Jun. 15, 2015.

(51) Int. Cl. H04W 28/02; H04L 12/801; H04W 28/12; H04W 24/02

(52) U.S. Cl. CPC H04W 28/0231; H04L 47/127; H04W 72/1231; H04W 28/12; H04W 24/02; H04W 28/0284

(57) ABSTRACT

Various communication systems may benefit from an improved wireless communications. For example, communication systems may benefit from regulating or controlling the download of data from a wireless network to a user equipment. A method includes analyzing at a network entity conditions affecting a user equipment receiving data from a data communication network. The method also includes determining whether the user equipment should perform an action relating to data delivery based on the conditions. In addition, the method may include sending information from the network entity to the user equipment indicating when the user equipment should perform the action.

### BACKGROUND

### Field

Various communication systems may benefit from improved wireless communications. For example, communication systems may benefit from regulating or controlling the download of data from a wireless network to a user equipment.

### Description of the Related Art

The use of mobile wireless devices for receiving data is increasingly important, and the delivery of video data is consuming an increasing share of available wireless capacity, both because of the popularity of video and because video applications inherently consume relatively great amounts of data. In the case of video data, various techniques such as media optimization and adaptive streaming servers have been employed to increase the system capacity and video quality in different networks. The network may utilize 3rd Generation Partnership Project (3GPP) technology, such as Long Term Evolution (LTE) or LTE-Advanced (LTE-A).

Media optimizers and adaptive streaming servers can be used to manage downloading of video to a user equipment, such as a camera phone, smart phone, tablet computer, smart watch, vehicle entertainment system, media player with wireless capability, or the like, just in time to be played. A just-in-time approach can avoid wasting of network resources when a user decides to abandon a video before it is complete, because it may avoid the transferring data that the user equipment will not use. In a just-in-time approach, however, a user may frequently be expected to experience a gap in coverage or impaired coverage, so that under some circumstances video will not be available at the moment it is needed.

Delivering data before it is needed, which may be referred to as pre-filling data, can avoid this interruption or degradation of video quality. The need for pre-filling of data can vary based on the particular circumstances of the user equipment. Video data, for example, can be configured so as to be playable by a single user equipment, as in the case in which video is encrypted with a key provided to one or more user equipment. Video data can also be playable to the single user equipment when digital rights management (DRM) is used, so that video is configured to be transferable only to a single UE.

If video data is to be reliably delivered, accommodations should be made for areas experiencing poor coverage or significant loads, which may interfere with the ability of the user equipment to receive data just-in-time for playback.

### SUMMARY

A method, in certain embodiments, may include analyzing at a network entity conditions affecting a user equipment receiving data from a data communication network. The method may also include determining whether the user equipment should perform an action relating to data delivery based on the conditions. In addition, the method may include sending information from the network entity to the user equipment indicating when the user equipment should perform the action.

According to certain embodiments, an apparatus may include at least one memory including computer program code, and at least one processor. The at least one memory and the computer program code may be configured, with the at least one processor, to cause the apparatus at least to analyze at a network entity conditions affecting a user equipment receiving data from a data communication network. The at least one memory and the computer program code may also be configured, with the at least one processor, at least to determine whether the user equipment should perform an action relating to data delivery based on the conditions. In addition, the at least one memory and the computer program code may also be configured, with the at least one processor, at least to send information from the network entity to the user equipment indicating when the user equipment should perform the action.

An apparatus, in certain embodiments, may include means for analyzing at a network entity conditions affecting a user equipment receiving data from a data communication network. The apparatus may also include means for determining whether the user equipment should perform an action relating to data delivery based on the conditions. In addition, the apparatus may include means for sending information from the network entity to the user equipment indicating when the user equipment should perform the action.

According to certain embodiments, a non-transitory computer-readable medium encoding instructions that, when executed in hardware, perform a process. The process may include analyzing at a network entity conditions affecting a user equipment receiving data from a data communication network. The process may also include determining whether the user equipment should perform an action relating to data delivery based on the conditions. In addition, the process may include sending information from the network entity to the user equipment indicating when the user equipment should perform the action.

According to certain embodiments, a computer program product encoding instructions for performing a process according to a method including analyzing at a network entity conditions affecting a user equipment receiving data from a data communication network. The method may also include determining whether the user equipment should perform an action relating to data delivery based on the conditions. In addition, the method includes sending information from the network entity to the user equipment indicating when the user equipment should perform the action.

A method, in certain embodiments, may include receiving information at a user equipment from a network entity based on a condition affecting the user equipment. The information indicates that the user equipment perform an action related to data delivery. The method can also include performing the action based on the received information while the condition is affecting the user equipment.

According to certain embodiments, an apparatus may include at least one memory including computer program code, and at least one processor. The at least one memory and the computer program code may be configured, with the at least one processor, to receiving information at a user equipment from a network entity based on a condition affecting the user equipment. The information indicates that the user equipment perform an action related to data delivery. The at least one memory and the computer program code may also be configured, with the at least one processor, to cause the apparatus at least to performing the action based on the received information while the condition is affecting the user equipment.

An apparatus, in certain embodiments, may include means for receiving information at a user equipment from a network entity based on a condition affecting the user equipment. The information indicates that the user equipment perform an action related to data delivery. The apparatus may also include means for performing the action based on the received information while the condition is affecting the user equipment.

According to certain embodiments, a non-transitory computer-readable medium encoding instructions that, when executed in hardware, perform a process. The process may include receiving information at a user equipment from a network entity based on a condition affecting the user equipment. The information indicates that the user equipment perform an action related to data delivery. The process may also include performing the action based on the received information while the condition is affecting the user equipment.

According to certain embodiments, a computer program product encoding instructions for performing a process according to a method including receiving information at a user equipment from a network entity based on a condition affecting the user equipment. The information indicates that the user equipment perform an action related to data delivery. The method may also include performing the action based on the received information while the condition is affecting the user equipment.

### BRIEF DESCRIPTION OF THE DRAWINGS

For proper understanding of the invention, reference should be made to the accompanying drawings, wherein:

FIG. 1 illustrates a wireless communication system according to certain embodiments.

FIG. 2 illustrates a system according to certain embodiments.

FIG. 3 illustrates a flow diagram according to certain embodiments.

FIG. 4 illustrates a diagram showing the reduced congestion rates provided by network knowledge sharing protocol embodiments of the present disclosure.

FIG. 5 illustrates an example network diagram of the network knowledge sharing protocol defined in the present disclosure.

FIG. 6 illustrates two tables showing LCID values according to certain embodiments.

FIG. 7 illustrates an embodiment of the network knowledge sharing protocol according to certain embodiments.

FIG. 8 illustrates an example flow diagram of the network knowledge sharing protocol according to certain embodiments.

FIG. 9 illustrates a table according to certain embodiments.

FIG. 10 illustrates a table according to certain embodiments.

FIG. 11 illustrates a table according to certain embodiments.

FIG. 12 illustrates a table according to certain embodiments.

FIG. 13 illustrates an example use case according to certain embodiments.

FIG. 14 illustrates an example use case according to certain embodiments.

FIG. 15 illustrates an example use case according to certain embodiments.

FIG. 16 illustrates an example use case according to certain embodiments.

FIG. 17 illustrates an example use case according to certain embodiments.

FIG. 18 illustrates an example use case according to certain embodiments.

FIG. 19 illustrates an example use case according to certain embodiments.

FIG. 20 illustrates an example of a table according to certain embodiments.

FIG. 21 illustrates an example of a table according to certain embodiments.

FIG. 22 illustrates an example use case according to certain embodiments.

FIG. 23 illustrates a flow diagram according to certain embodiments.

### DETAILED DESCRIPTION

Certain embodiments allow for a method, apparatus, computer program, or other embodiments in which the user equipment may receive data during times when it may be efficiently delivered, so that the data will be available for playback during a period of slow delivery, or when no delivery occurs.

While many of the embodiments described below are introduced in terms of video data, the embodiments may also be applied to any other form of data. Video data may include video, video or audio data, media, media data, video and audio data, or audio data. Specifically, certain embodiments apply to data that can be delivered as needed in order to use the transmission capacity of the network and/or the user equipment efficiently. Various conditions may be evaluated by the network and the user equipment in order to determine whether data should be delivered before it is immediately needed. In other words, certain embodiments allow for data to be pre-filled according to certain conditions experienced by and network and/or user equipment.

In certain embodiments, a network entity may provide data to the user equipment, even though the decision to request data from the network entity can be made by the user equipment. The network entity may send the user equipment information and/or predictions that the user equipment may use to determine whether to maintain, improve, downgrade, upgrade, or halt data delivery. For example, the user equipment may, in some embodiments, determine when to request pre-filling of data based on the information received from the network entity.

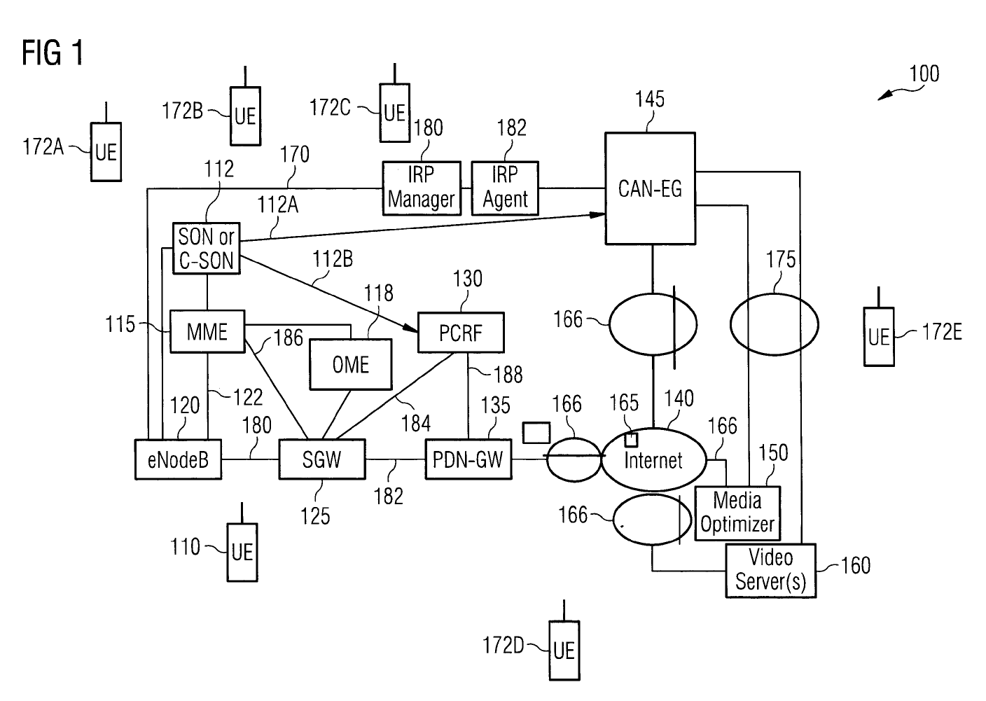

FIG. 1 illustrates a wireless communication system according to certain embodiments. Specifically, FIG. 1 illustrates an example of a video server radio access network (RAN) interfaced architecture for a cell, such as a macro cell. The architecture includes a user equipment 110 communicating via a wireless connection 105, including uplink and/or downlink data transmissions, with a network 100. Network 100 can include, for example, at least one of an eNode B (eNB) 120, a self-optimizing network (SON) or a centralized self-optimizing (C-SON) server 112, a serving gateway (SGW) 125, a mobility management entity (MME) 115, an operations and management entity (OME) 118, a policy and charging rules function (PCRF) network element 130, a packet data network gateway (PDN-GW) 135, a content aware network-enabling gateway (CAN-EG) 145, a media optimizer 150, or at least one video server 160.

Network 100 may be coupled to the Internet 140, and in particular may be coupled to a content source 165 on Internet 140. SON or C-SON server 112 may be connected to the CAN-EG 145 using an interface 112A. SON or C-SON server 112 may also be connected to the PCRF element 130 using an interface 112B.

In certain embodiments, eNB 120 can be connected to the SGW 125. The connection may be accomplished, for example, by an S1-U interface 181. The SGW 125 can be connected to the PDN-GW 135, for example, by an S5/S8 interface 182, and to the PCRF 130, for example, by a Gxx/Gxa interface 184. The SGW 125 may also be connected to MME 115 by S11 interface 186. The PDN-GW 135 can be connected to the PCRF 130 by a Gx interface 188. The Internet 140 can then be connected to the CAN-EG 145, the media optimizer 150, the at least one video servers 160, and the PDN-GW 135 via multiple networks 166 implementing at least internet protocol (IP) interfaces.

A network 175 may implement, for example, a diameter protocol that may providing an authentication, authorization, and accounting (AAA) framework, over a stream control transmission protocol (SCTP) and a transport layer protocol. A network 170 may be configured to carry general packet radio service (GPRS) tunneling protocol (GTP) messages. A network 170 connecting CAN-EG 145 and eNB 120 may include a GTP user plane (GTP-U) interface. GTP-U protocol can be used over S1-U, X2, S4, S5, and/or S8 interfaces of the Evolved Packet System (EPS).

The network 100 may also include an Interface Reference Point (IRP) manager 180 and an IRP agent 182. The IRP manager 180 can control self-optimization functions, while the IRP agent 182 can allow the IRP manager to know the success and/or the failure of self-optimization functions.

The network entities in network 100 shown in FIG. 1 are merely exemplary. Network 100 may include any number of entities, some of which can be different from those shown in FIG. 1. In addition, the network entities or elements shown in FIG. 1 may be located in different parts of the network. The various networks and the corresponding implementation of interfaces and/or protocols are also merely exemplary.

The various network entities elements of the radio access network (RAN) may be radio access technology (RAT) specific. For instance, in LTE, the network can be Enhanced Universal Terrestrial RAN (EUTRAN)/Enhanced Packet Core (EPC). The eNB may be a component of the RAN/EUTRAN, whereas the MME, SON or C-SON, SGW, PDN-GW, or PCRF may be parts of the Evolved Packet Core. In Universal Mobile Telecommunications System (UMTS), the Node B and the radio network controller (RNC) may be part of the RAN while the serving GPRS support node (SGSN), gateway (GGSN), and PCRF may be part of the core.

In the embodiments of FIG. 1, UE 110 may connect to content source 165 in Internet 140 to download video, or any other form of video data, via the media optimizer 150. Optimized content can be streamed from media optimizer 150 or at least one video server 160 to PDN-GW 135, which may forward the content to the SGW 125. SGW 125 can then forward the content through the eNB 120 to UE 110.

CAN-EG 145 may allow at least one video server 160 and media optimizer 150 to establish and/or modify the bearer characteristics between PDN-GW 135 and UE 110 by making the requests to CAN-EG 145. CAN-EG 145 may collect network metrics from the eNB 120 and/or other network elements, and report the network metrics to media optimizer 150 and video server 160. In some embodiments, media optimizer 150 and video servers 160 may communicate with eNodeB 120 using the network 170 via CAN-EG 145. At least one video server 160, for example, may act to cache video from content source 165. As such, at least one video server 160 may be considered a surrogate server, as at least one video server 160 can contain cached copies of the video data in content source 165.

Network 100 may also utilize small cell architectures, such as pico, micro, or femto cells in LTE-A. A zone eNB (ZeNB) controller, used for controlling multiple eNBs, and content delivery network (CDN) surrogate may also be included in network 100.

In certain embodiments, an SON function may reside in at least one network element, such as an SON server, a C-SON server, Node B, eNB, or MME of wireless network 100. The SON function may be used to monitor and/or determine conditions affecting a UE during the time period in which the UE is receiving and/or playing video data. The conditions may for example, be associated with an information capacity, load, or throughput, of a communication channel or any network entity with which the UE communicates. In other embodiments, conditions may be a cost of transmitting information from an application through the wireless network to the UE. Such a cost may depend on, for example, factors such as the modulation scheme being used, and may be expressed in terms of cost per bit of information. The UE, in certain embodiments, may use any of the above specified conditions to determine whether to perform an action.

Wireless network 100 can serve a plurality of UEs such as UE 110, UE 172A, UE 172B, UE 172C, UE 172D, and UE 172E, which may receive network services, and whose use of resources affects the resources available for any given UE, such as UE 110. UEs 110 and 172A-172E may have different relationships to the network 100, in certain embodiments. One or more UEs may experience different guaranteed service levels, experience conditions, and/or events that change over time and that differ among the UEs. Wireless network 100 can implement a policy administered by OME 118, IRP manager 180, and/or IRP agent 182. IRP agent 182 may support the IRP manager 180 in defining policy directions when the SON functions request conflicting parameter values. If no policy directions are given, IRP agent 182 may instruct IPR manager 180 to apply a default policy direction.

A policy direction may describe an expected behavior from IRP agent 182. Examples for the policy direction may include prioritizing SON functions in case two or more SON functions request conflicting values, prohibiting further changes of a parameter for a specific amount of time, selecting preferred value ranges, or directing IRP agent 182 to report conflicts. In an embodiment involving a conflict between SON functions, if IRP agent 182 cannot resolve a conflict, the IRP agent 182 can help IRP manager 180 determine parameter values.

IRP agent 182 may also help IRP manager 180 to configure a SON coordination policy. The coordination policy may include coordination between different self-optimizing functions and between different targets within one self-optimizing function.

The policy may also define the conditions that the network entity can take into account when making service predictions, and/or to which user equipment the prediction can be delivered. If a prediction by the network entity causes video data to be delivered to a UE for pre-filling, the policy which dictates how the prediction is made can affect the UE. In addition, the video data's delivery to the UE, and the UE's subsequent action in response to the prediction, can have a significant impact on the availability of resources for other UEs. Therefore, in certain embodiments the conditions under which a prediction relating to pre-filling of video data may be delivered to a UE can be defined by a policy. In some embodiments, the policy may also define how the UE receiving the prediction can interpret and/or act on such predictions.

When making predictions, the network entity may take into the quality of service to which the UE is entitled, the likelihood that the particular UE will encounter degraded conditions that will impair timely delivery of data, and/or the likelihood that the UE will encounter above-average conditions so that it can receive buffered data without excessively impacting other UEs. The predictions may vary based on the time period taken into account, and the time for which the predicted events or conditions are expected to last.

Predictions may also be made by the network entity based at least in part on a specific network rule for self-optimization. The rule for self-optimization may be set by the SON or C-SON. Predictions may be made based on different levels of the network. For example, predictions may be based on the network as a whole, at a cell level, at a macro cell, in overlapping smaller cells, such as micro and pico cells, or according to specific eNB, and the conditions affecting its operation.

In certain embodiments, eNB 120 may perform its own measurements and/or receive measurements from UEs that are currently receiving video data, such as UE 110. eNB 120 may also receive measurements from other UEs in the network or the network environment, such as UEs 172A-172E. One or more network elements may then analyze the measurements, for example, at a service level at the UE, and make predictions based on the measurements. A service level may include a rate of delivery and a quality of data delivery that can be provided to the UE 110. Predictions relating to changes in service, which may constitute either degradations or improvements in service, can be communicated to UE 110, which is currently receiving video data, or which will receive video data in the future.

A network entity or element, in certain embodiments, may determine, based on measurements made by UE 110, that the UE may be approaching a coverage hole. A coverage hole may be defined as an area of diminished coverage relative to the network average. The coverage hole may include any level of diminishment below the network average, whether it be a small or a large diminishment. Based on the predicted coverage hole, the network entity or element may determine that the UE should pre-fill data while still being in a good coverage area. This determination by the network entity may be made based at least in part on a cost calculation in which communication in an area of low coverage is assigned a higher cost than in an area of greater coverage.

Similarly, areas or times of high network loading, which experience high network traffic, may be assigned a higher cost than areas or times of low network loading. A network element may determine that the UE may pre-fill data while in an area of low network loading or at a time of low network loading. Various other factors may be taken into account when determining whether to maintain, improve, or stop data delivery by the UE.

Network 100 may deliver or send information to the UE that can be interpreted as indicating a need to maintain or improve data delivery. In other words, the information sent to the UE may indicate that the UE should pre-fill data, save resources, or otherwise take steps to maintain the quality of the user's experience. Upon receiving the information, which may include predictions of impairment or explicit indications that data should be pre-filled, the UE may make the information available to mobile applications operating on the UE through an application programming interface.

In certain embodiments, one or more network elements or entities may be used to make predictions that can be used to determine when and how a UE should request data. Such predictions may be specific to a particular UE, and may depend on the status of a UE. One or more network entities may be included in the decision relating to how the predictions are made by the network and communicated to the UE. For example, the network may use or create specific controls, targets, or key performance indicators (KPIs) determining specific characteristics of the predictions that are to be made. Such predictions may then be provided to UEs based on determinations made by the one or more network entities. For example, OME 118 may set a policy controlling which predictors are to be sent to which UE.

As an example, if a UE is entitled to an elevated level of service, more network resources may be dedicated to delivering video data to the UE. In such an embodiment, the prediction may increase the likelihood that the UE will receive data before it is needed. Predictions may also take into account specific events associated with particular UEs, such as a movement of the UE toward a location that provides poor coverage or, on the other hand, movement of a UE into or out of a location that provides good coverage.

The determination as to whether or not the UE should pre-fill video data, or otherwise, maintain, improve, or halt data delivery, may be evaluated based on expected communication costs. The cost may be expressed in terms of the communications resources needed to deliver the video data. When the UE 110 is in an area of good coverage, pre-delivering video, even if that video is abandoned, may in certain embodiments be less costly than delivering video just-in-time for playback. On the other hand, when UE 110 is in a poor coverage area, the UE may want to avoid pre-filling or having data pre-delivered until just-in-time for playback.

As discussed above, predictions by the network entity on the UE's condition may include or be based on a number of factors or events. Factors may include, for example, anticipated call drop, which may be based on radiofrequency conditions, measurements taken by the UE or any other network entity, UE reports, and/or any other factor that may be helpful in the determination.

Another example of a factor may include anticipated quality of service degradation. Quality of service degradation may indicate that the network is unable to support the UEs required quality of service in terms of throughput, time budget, and/or other similar parameters. Possible events, which may be taken into account when determining a prediction, may be energy savings events, such as cell shutdown, anticipated handover, which might be an inter-radio access technology (iRAT) handover, and/or other similar events, which may lead to a temporary or permanent quality of service degradation.

In a distributed self-optimizing network, such as network 100 shown in FIG. 1, IRP agent 182 may provide support for IRP manager 180 to define the UE notification policy by SON functions. A notification policy, as discussed above, involves a policy determined by the network for when the UE may be notified of a prediction. An SON function, for example, may be used to predict a service degradation or improvement affecting UE 110. The notification policy may include specific event types, specific targets, key performance indicators (KPIs), thresholds, controls, or any other factor or trigger that can be used by the notification policy. The notification policy may also include a specific depth of prediction, expressed in terms of time, and/or specific self-optimizing network functions. The policy may also include an architectural level of prediction, such as the eNB, cell, or other level of prediction, and may designate specific UE groups based on, for example, a quality of service level.

For a hybrid SON server, an OME, and/or a C-SON server, IRP manager 180 and IRP agent 182 may be used to provide for a higher level or higher scale of predictions, including energy savings and cell or system boundaries. In certain embodiments, predictions may be provided as part of a premium service for a general higher level of service, or for a service directed to providing and/or acting on predictions so as to prevent interruption of a user's video.

Once the UE receives information from the network entity, and the UE may perform an action based on a condition affecting the UE. The information received from the network entity may inform the UE, for example, that service degradation is expected, and that the UE should take actions to maintain the quality of the user's experience or to minimize transmission costs. An example of one possible action by the UE may be to pre-fill video data while still experiencing satisfactory or better than usual network conditions. An example of another possible action may be to postpone activities requiring heavy data usage until poor conditions have ended. One condition under which such an action may be particularly appropriate may be during a handover, or when the UE is on the threshold of a handover. In such an embodiment, the UE may be at the edge of a cell, and may expect to experience better conditions once handover has been completed to new cell.

A network entity or element, such as OME 118, may prepare a message or a signal to UE 110 that includes information indicating to the UE of conditions affecting the UE, and then determine whether the US should perform an action based on the conditions. For example, the message or signal may include information such as estimated time until impairment, estimated duration of impairment, or other relevant information.

In certain embodiments, the amount of pre-fill the UE chooses to receive may be influenced by the amount of video watched so far, and the probability that the user of the UE will abandon the video, which may also change depending on the amount of video watched. Another factor in determining the amount of pre-fill may be the setup and loading time of video data. An assumption may be made that when a user has waited through a longer setup time, the user is more likely to watch the video all the way through. Another factor that may be taken into account includes abandonment history for a particular user. If a user has a history of abandoning videos after a short time, the likelihood that the UE will need to pre-fill data can be substantially reduced by comparison to a user that may tend to watch videos to the end.

In certain embodiments, a radio access network may predict an impairment of the air interface, and UE 110 may be notified of the prediction by an eNB, of another network entity. The prediction may come in the form of a message that includes information such as an estimated time until the impairment, the estimated duration of the impairment, and any other related information. As an example, the message can be a radio resource control message, and the UE may pass the indication, as well as any additional information included in the message or the indication, to the upper layers for handling.

In one example the following assumptions may be made regarding the operation of network 100:
Cell radius—0.6 kilometer (km).
Cell to cell distance—approximately 1 km.
Mobility model—30% “mobile users” (traveling at >30 km per hour (km/h))
   70% “static users” (traveling at <30 km/h).
Number of access attempts overall (all users in all radio frequency conditions) N
Cost of initiating a service: Y information bits
Modulation: quadrature phase shift keying (QPSK) and quadrature amplitude modulation (QAM)
QPSK—“bad” RF
QAM—“good” RF
“bad RF”—QPSK—average symbols/information bit=1.9
“good RF”—QAM—average symbols/information bit=0.4.

Pre-filling video data may allow for the carrying of services in good RF conditions. Without pre-filling, such services would be carried out in bad RF conditions. For example, assume that an average mobile user, currently in good RF conditions, will be in bad RF conditions within approximately the next two minutes or less, which is the time required to travel 1 km at 30 km/h. If 30% of the users are mobile users, then allowing pre-filling of video allows for 30% of services to be carried under good RF conditions, which would otherwise be carried under bad RF conditions.

Defining the cost of access attempts without pre-filling, in terms of an RF cost of access attempts, is:

(N/3*0.4Y)+(2N/3*1.9Y)=1.4*N*Y.

The costs of access attempts with pre-filling allowed is:

(N/3*0.4Y)+(0.3*2N/3*0.4Y)+(0.7*2N/3*1.9Y)=1.1*N*Y.

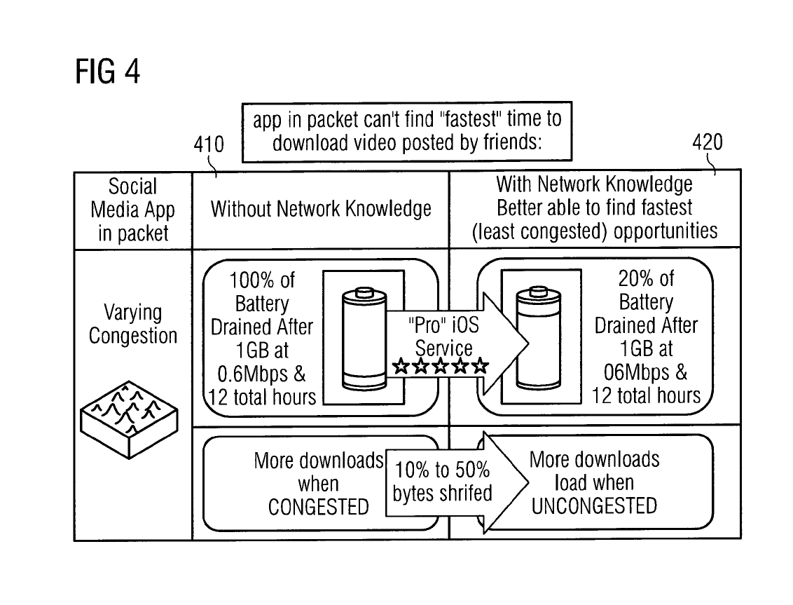

In the above example, allowing pre-filling of data according to certain embodiments allows for a 21% improvement. FIG. 4 illustrates an example of how the above described embodiments can increase the battery efficiency of a UE.

In some embodiments, an evaluation may be conducted to determine when a UE is in an area of favorable coverage, such as in close proximity to an eNB or in a less loaded cell, that is, a cell with fewer UEs competing for resources provided by a network entity, such as an eNB. Under such favorable circumstances, pre-filling may be desirable because if the UE 110 is in an area of exceptionally favorable conditions, it is likely that the UE will shortly move to an area of less favorable coverage. This is true because if conditions are above average or well above average, any change is likely to lead to conditions nearer to the average. Under these circumstances, the savings in cost may be similar to those determined in the above example. In addition, differences in conditions, such as a different number of mobile versus static users, or a difference in the average symbols per information bit in bad RF versus good RF, can result in changes in the comparative costs.

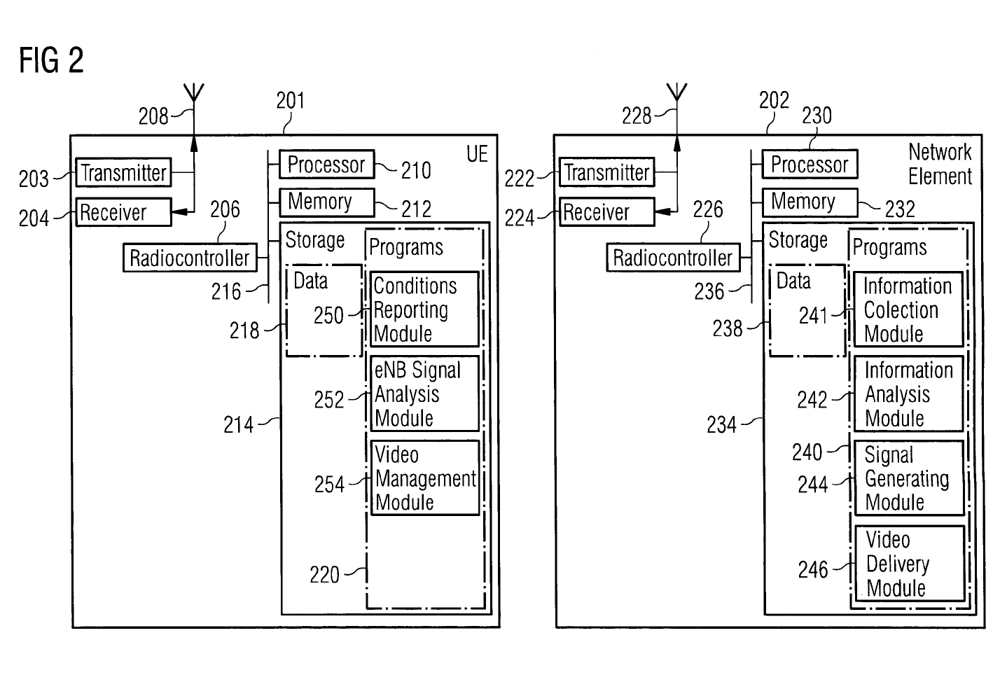

FIG. 2 illustrates details of UE 201 and a network entity or element 202, such as an LTE network element. Network element 202 may be a SON, C-SON, eNB, CAN-EG, MME, OME, IRP agent, IRP manager, or any other appropriate network element or entity. UE 201 can comprise a transmitter 203, receiver 204, radiocontroller 206, and an antenna 208. UE 201 may also include a processor 210, memory 212, and storage 214, communicating with one another, as well as with a radiocontroller 206 over a bus 216. UE 201 can employ data 218 and programs 220, suitably residing in storage 214 and being transferred to memory 212 as needed for use by the processor 210.

Network element 202 can include a transmitter 222, receiver 224, radio controller 226, and antenna 228. The network element 202 may also include a processor 230, memory 232, and storage 234, communicating with one another and with a radio controller 226 over a bus 236. The network element 202 can employ data 238 and programs 240, suitably residing in storage 234 and being transferred to memory 232 as needed for use by the processor 230. Each of the programs or modules described in relation to network element 202 or user equipment 201 may be performed by hardware, such as processor 210, 230, memory 212, 232, transmitter 202 222, and/or receiver 204, 224.

Among the programs 240 employed by the network element 202, an information collection module 241 is included for monitoring conditions affecting UE 201, and an information analysis module 242, which may analyze information to make predictions relating to future conditions and/or determine whether the UE should improve, maintain, or halt data delivery. Network entity or element 202 also includes a signal generating module 244 for generating appropriate signals. The network element 202 includes a video delivery module 246, which responds to requests from the UE and delivers video data to fulfill the requests.

The UE 201 can include a condition reporting module 250, reporting channel conditions to network element 202, as well as an eNB signal analysis module 252, which receives signals from network element 202, such as signals indicating predictions that channel conditions will be impaired, or simply that a UE should take steps to improve or maintain the user's video experience, such as by pre-filling data, compressing data, or pausing activities requiring heavy data use. The network element signal analysis module 252 can examine the signals received from network element 202, and choose an appropriate action to be taken by the UE. The response, in certain embodiments, may entail an action. The UE 201 can further include a video management module 254, which directs appropriate actions, for example, requesting additional video data, increasing compression, pausing activities requiring a heavy data load, or any other action by the UE. The video management module 254 can also manage receiving and playing of video data to provide for a smooth video delivery to the user.

Various embodiments of memory 212 and 232 and storage 214 and 234 may include any data storage technology type which is suitable to the local technical environment, including but not limited to semiconductor based memory devices, magnetic memory devices and systems, optical memory devices and systems, fixed memory, removable memory, disc memory, flash memory, dynamic random access memory (DRAM), static random access memory (SRAM), electrically erasable programmable read-only memory (EEPROM), or any other type of memory. Various embodiments of processor 210 and 230 may include, but are not limited to, general purpose computers, special purpose computers, microprocessors, digital signal processors (DSPs), and multi-core processors.

The various modules 242-246 and 250-254 may each be implemented as an application computer program stored, for example in the memory 212 and 232 and storage 214 and 234. In other embodiments, modules 242-246 and 250-254 may be implemented as software, firmware, or hardware modules or a combination thereof. In particular, in the case of software or firmware, one embodiment may be implemented using a software related product such as a non-transitory computer readable memory, computer readable medium, or a computer readable storage structure comprising computer readable instructions such as program instructions using a computer program code. The computer program code may be, for example, the software or firmware) stored on the computer readable memory, and may be thereon to be executed by a computer processor.

Modules 242-246 and 250-254 may also be implemented as separate blocks or may be combined with any other module, or blocks of the module may be split into several blocks according to their functionality. Moreover, all or selected modules may be implemented using an integrated circuit by, for example, using an application specific integrated circuit (ASIC).

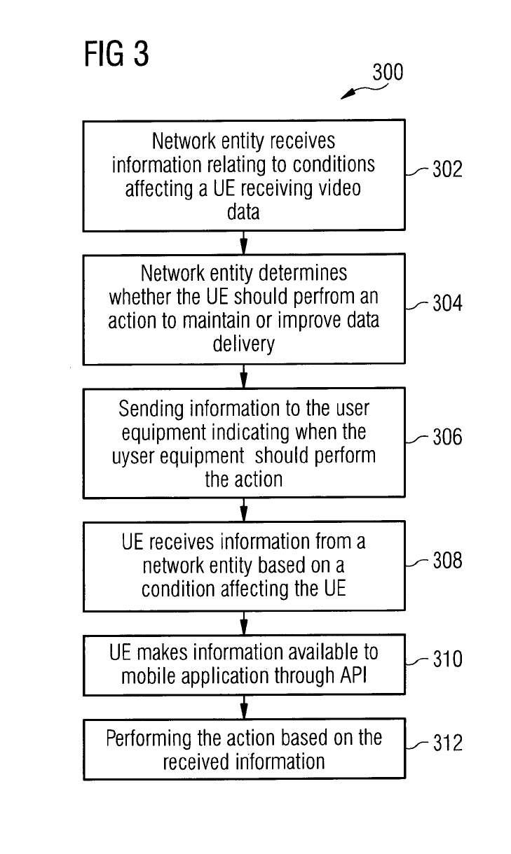

FIG. 3 illustrates a process 300 according to certain embodiments. The particular order of steps illustrated in FIG. 3 are merely exemplary, one or more steps may be skipped, different steps may be added or substituted, or selected steps or groups of steps may be performed in a different process. At step 302, a network element or entity in a self-optimizing network similar to the network 100 of FIG. 1, can receive measurements relating to network conditions affecting at least one UE. The conditions may relate to conditions affecting the receiving of video data by the at least one UE.

At step 304, network element or entity can evaluate or analyze the conditions, taking into account factors, such as coverage, the movement of a UE into an area of better service or worse service, and/or demands by other UEs for resources, and other relevant factors. Based on this evaluation or analysis, the network entity may determine whether the UE should perform an action to maintain, improve, or halt data delivery in order to ensure the user's experience. Such actions by the UE, for example, may include pre-filling video data, compressing video data, suspending applications presenting a higher demand for data, and any other action that can be used to ensure the user's experience, or to improve the efficiency of the network and/or the UE. The determination may in some embodiment be made, in part, based on an expected likelihood that the user will abandon the video.

At step 306, the network element or entity may signal or send a message to the UE. The signal or message may include an indication and/or relevant information as to whether there is a need to take action to maintain the user's video data experience. In step 308, the UE may receive the information from a network entity based on a condition affecting the UE. The information may indicate that the UE should perform an action related to data delivery. In step 310, the UE may make information received from the network entity available to mobile applications using video data through an application programming interface.

In step 312, the UE, or applications run within the UE, may request video data from the network for pre-filling or take any other action as needed. In other words, in step 312 the UE may perform an action based on the information received from the network entity, while the condition identified by the network entity is affecting the UE. In step 312, the UE may request the network entity to either maintain delivery of data before it is needed, or to increase data compression. In certain embodiments, the UE may suspend activities of high data demand in response to the received information.

FIG. 4 illustrates a diagram showing the reduced congestion rates provided by the network knowledge sharing protocol according to certain embodiments. Specifically, FIG. 4 illustrates battery usage of a UE running a social media application that is downloading a video posted by another social media user. Column 410 illustrates battery usage in a user equipment without network knowledge, or without the above discussed embodiments. In a 12 hour span, one hundred percent of the battery of the user equipment may be drained after downloading 1 gigabyte at a rate of 0.6 megabits per second. The battery usage in column 410 may be reflective of downloading data during congested data traffic times.

Column 420, on the other hand, illustrates battery usage in a UE with network knowledge, as discussed in the above embodiments. In a 12 hour span, twenty percent of the battery of the user equipment is drained after downloading 1 gigabyte at a rate of 6 megabits per second. The battery usage in column 420 can be reflective of having more downloads during uncongested or less congested data traffic times.

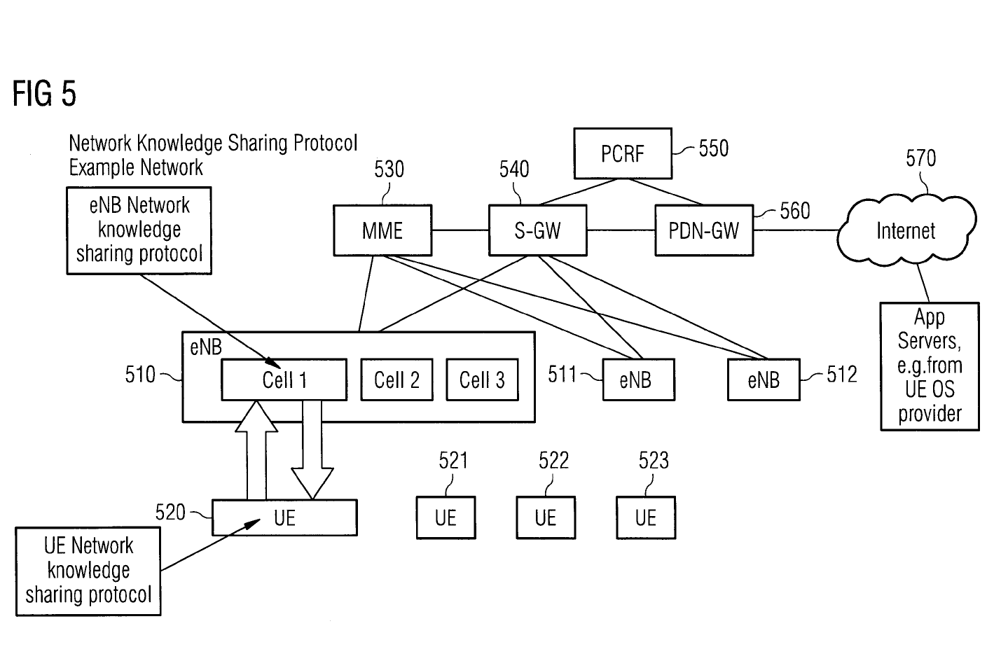

FIG. 5 illustrates an example of a network diagram of the network knowledge sharing protocol according to certain embodiments. The knowledge sharing protocol may use specific processes to convey information from the network to the UE. Such a protocol can allow the UE, or an application running on the UE, to take action based on information received from the network.

In certain embodiments, the protocol may allow the UE, or an application or operating system within the UE, to convey specific application relevant information to a network entity. The network entity can then incorporate the information received from the UE with other information it derives from the network to make an informed decision. The informed decision may relate to analyzing conditions affecting the user equipment, and determining whether the UE should perform an action based on such conditions.

In some embodiments, only a subset of the UEs may support the network knowledge sharing protocol. For example, the protocol may be a proprietary protocol, which may be implemented by only a subset of the UEs. In such an embodiment, the broader set of UEs, meaning all of the UEs in the network, may implement cellular standardized messaging. However, a specific subset of these UEs may implement an additional proprietary protocol, which may support this knowledge sharing protocol.

The network knowledge sharing protocol may provide battery life, and capacity benefits, such as, reducing the total amount of time and power transmitted to or from the UE. The protocol may reduce the total amount of time and power used by avoiding scenarios in which there are excess or unnecessary uplink or downlink transmissions. An example of such a time period, in which transmissions are unnecessary, may be that after a background transfer has just completed, or a streaming playout buffer has just finished being overfilled to a deeper than necessary depth. The protocol may also reduce the total amount of time and power used by ensuring that transfer occur where the network is relatively uncongested, such that the total time to complete the transfer is relatively brief.

In certain embodiments, if the link speed achieved during a transfer is increased by a multiplicative factor of 10, then it may be possible to reduce the total amount of current drain by approximately a multiplicative factor of five. This follows from a case where the modem on time is reduced by approximately a multiplicative factor of 10, and the current drain during the download is increased only by a multiplicative factor of two, while it is downloading at a much higher link speed (one which is 10 times faster). This embodiment may also include the UE immediately returning to idle at the end of the background transfer. The UE can return to idle more quickly because the download completed more quickly. In addition, the UE may transition even more quickly to idle because the network may know that this particular transfer is a background transfer.

FIG. 5 illustrates an example of a network diagram of the network knowledge sharing protocol according to certain embodiments. The system may include UEs 520, 521, 522, 523, and eNB 510, 511, 512. In the embodiment of FIG. 5, UE 520 and eNB 510 are both part of the network knowledge sharing protocol. UE 520 may be considered a subset of the UEs using the protocol that may be proprietary. In other embodiments, other UEs and eNBs may also be included in the network knowledge sharing protocol. The system of FIG. 5 also includes MME 530, serving gateway (S-GW) 540, PCRF 550, PDN-GW 560, and internet 570. Internet 570 may include application servers, for example, a UE operating system provider.

According to certain embodiments, a network entity may determine that a subscriber or a UE supports the knowledge sharing protocol. In some embodiments, the network entity may determine that the UE supports this proprietary knowledge sharing protocol by first checking at least one of the UE's international mobile station equipment identity (IMEI or IMEISV), or a masked version of the IMEISV. The IMEISV may contain information on the individual mobile equipment and software version. Additionally, the masked IMEISV can store this information, with other user identity information masked or obscured. In this embodiment, the network entity, such as an eNB, can use the IMEISV to determine that the subscriber has additional proprietary capabilities, above and beyond those specified within the 3GPP standard for that particular LTE release, such as the knowledge sharing protocol.

In another embodiment, the entity may determine that the subscriber supports the proprietary or knowledge shared protocol by using a deep packet inspection, to detect whether a unique signature was transmitted by the subscriber UE. The unique signature may have been transmitted, for example, immediately after the UE connects to a network entity, such as an eNB.

In yet another embodiment, a premium subscriber service may be included. In this embodiment, a UE that support the knowledge sharing protocol is given a status which gives it a privilege, such a knowledge sharing protocol, for some specific premium subscriber service. The network entity, such as an eNB, may inform the UE whether a particular user of the UE is a subscriber with access to a particular premium service. If the eNB determines that the subscriber qualifies for this particular premium service, then the eNB knows that the knowledge sharing protocol is supported. The eNB may then transmit a downlink knowledge sharing message to the UE, thereby informing the UE that the knowledge sharing protocol is supported at that cell.

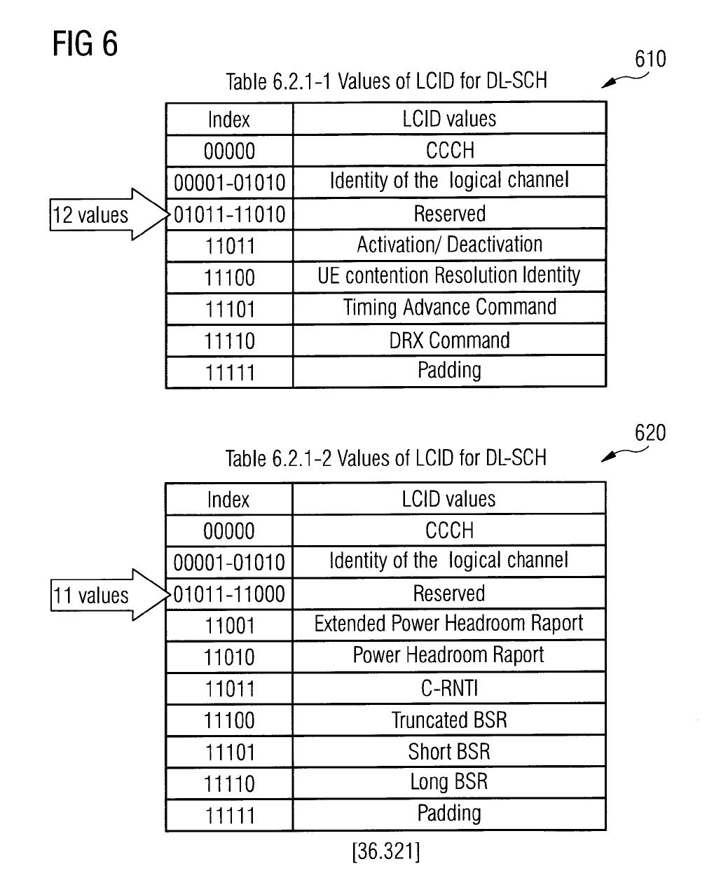

In response to the network entity determining that the subscriber UE supports the proprietary knowledge sharing protocol, the eNB may initiate transmission of a downlink knowledge sharing message to the UE, as shown in FIG. 5. The message may be an (LTE) media access control (MAC) message, known as a communication element within the 3GPP standard. The message may use one of the currently unused (or reserved) indexes 610 shown in Table 6.2.1-1 of FIG. 6.

FIG. 6 illustrates two tables showing universal terrestrial RAN (UTRAN) Cell ID (LCID) values according to certain embodiments. As can be seen in FIG. 6, there may be 12 unused or reserved values 610 for downlink scheduling. The downlink knowledge sharing message transmitted to the UE may use one of these unused or reserved values 610.

In certain embodiments, the UE may also determine whether it can begin using the knowledge sharing protocol. In some embodiments, when the UE receives a downlink knowledge sharing protocol message, the UE may then be allowed to utilize the knowledge sharing proprietary protocol, including, for example, transmitting uplink knowledge sharing protocol messages to the network entity.

The knowledge sharing protocol can in certain embodiments avoid reliance upon IMEISV to detect support for the knowledge sharing protocol support verification. The UE may, in certain embodiments, use over the top signaling, such as web signaling, to retrieve a list of cells which support knowledge sharing protocol. The UE can then cache or store information of the knowledge sharing protocol support at a particular cell. In another embodiment, wireless local area network (WLAN) service set identifiers (SSID) information can potentially be used to advertise a support of a network entity for the network knowledge sharing protocol.

In certain embodiments, the UE may determine that a particular cell supports the knowledge sharing protocol, because it may have recently received an indication over the downlink knowledge sharing protocol that one or more of the neighboring cells supports the knowledge sharing protocol.

In another embodiment, the UE, also known as the first UE, may determine that the network entity supports the knowledge sharing protocol when the UE receives an indication from an application server and/or another UE, also known as a second UE. This second UE may have determined that this particular cell supports the knowledge sharing protocol through one of a number of different methods, including that the second UE may have received a downlink knowledge sharing message from the cell. The cell may have identified itself as having the corresponding attributes such as cell ID, mobile country code (MCC), public land mobile network (PLMN), and location. The second UE may, in certain embodiments, have informed the first UE directly or an application server, which may have informed the first UE that this particular cell supports the knowledge sharing protocol. The first UE may then be able to determine that this particular cell supports the knowledge sharing protocol by observing the attributes associated with the cell, and comparing that with the information received from the application server and/or second UE. The first UE may then conclude whether a particular cell supports the knowledge sharing protocol.

Certain embodiments may reduce knowledge sharing messaging from the network entity used for indicating knowledge sharing protocol support. In other words, certain embodiments allow a UE to cache knowledge of the knowledge sharing protocol support at a particular cell. The UE's operating system (OS) can cache information on knowledge sharing protocol support at a particular cell. For example, the UE may cache information in an embodiment in which the UE briefly goes idle before reconnecting at the same cell. UEs using a same OS may then share this knowledge sharing protocol support information with the UE operating system ecosystem, such as with other devices using the same OS.

However, when a UE caches the knowledge sharing protocol support information, it may be possible for the knowledge sharing capabilities of a particular cell may be turned off. The UE in certain embodiments should be made aware that the cell no longer supports the protocol. Otherwise, UEs may continue to expect the knowledge sharing protocol to be supported, and subsequently transmit knowledge sharing messages to a network entity, which does not support knowledge sharing. The network entity may then suffer degraded performance when receiving, for example, MAC messaging over reserved indices for which it is not configured to process. In other embodiments, it may be that a self-optimizing network or network entity, may determine to turn off the knowledge sharing protocol at specific cells, in specific locations and/or times, where the benefit of such a protocol has decreased, and/or when the overhead generated by the knowledge sharing protocol is substantially degrading the performance of the network or the network entity.

In one embodiment, the cached knowledge of the knowledge sharing protocol support can automatically expire after a given interval of time, such that the UE can purge the cached information after it has not been reconfirmed for more than a threshold time interval. In another embodiment, one or more UEs may receive an explicit downlink message over the knowledge sharing protocol indicating that the protocol support is ending shortly. This indicator may then further be shared with an application server, associated with the knowledge sharing protocol and/or the UE type, and/or any other knowledge sharing UEs.

In certain embodiments, the first UE may have determined that the network or network entity supports the knowledge sharing protocol by observing certain peer-to-peer signaling, from other UEs within its proximity. For example, a second UE subscriber may transmit particular device-to-device (D2D) signaling, indicating to the first UE that a particular cell supports the knowledge sharing protocol. D2D signaling may include at least one of: WLAN signaling, Bluetooth signaling, or 3GPP D2D signaling.

In some other embodiments, a first UE subscriber or a first UE may determine that a cell supports the knowledge sharing protocol by observing certain non-cellular signaling, such as WLAN and/or Bluetooth, which are being advertised by the non-cellular network entity as having capabilities co-located within the cellular access point. For example, a particular WLAN SSID, WLAN pre-association information, or Bluetooth name may be transmitted by the WLAN and/or Bluetooth capability co-located within the cellular access point. Certain embodiments may use authentication or encrypted WLAN and/or Bluetooth identifiers in order to further indicate or authenticate to the UE that the knowledge sharing protocol is supported by that cell.

In certain embodiment the first subscriber may determine that the network or the network entity supports the knowledge sharing protocol by observing the configuration of the cell, corresponds to a particular predetermined pattern. When the UE observes that the cell configuration matches this pattern, the UE may conclude that this cell supports the knowledge sharing protocol.

In some embodiments, the UE may determine that the network or network entity supports the knowledge sharing protocol by retrieving this information directly from the cellular system, such as the operations and maintenance (OAM) subsystem, where knowledge sharing protocol support provides this information to a server associated with the UE using the knowledge sharing protocol. The UE may retrieve this information on a per cell basis or a per location basis.

When the UE determines that it can use the knowledge sharing protocol, it may transmit uplink knowledge sharing messaging to a network entity. The uplink message may be sent over a MAC message, known as a communication element within the 3GPP standard. The message may use one of the currently unused (or reserved) indexes as illustrated in Table 6.2.1-2 of FIG. 6.

As discussed above, FIG. 6 illustrates two tables showing LCID values according to certain embodiments. As can be seen in FIG. 6, there may be 11 unused or reserved values 620 for uplink scheduling. The uplink knowledge sharing message transmitted to the network entity may use at least one of these unused or reserved values 620.

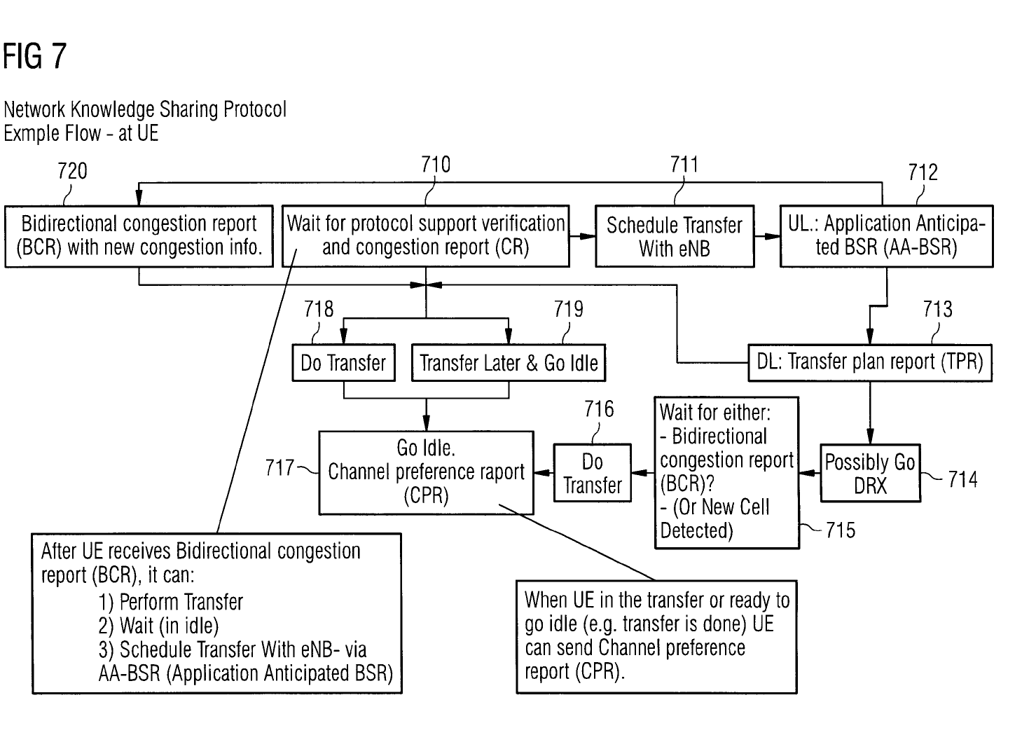

FIG. 7 illustrates an embodiment of the network knowledge sharing protocol according to certain embodiments. Specifically, FIG. 7 is an example of a knowledge sharing protocol flow at the UE. In step 710, the UE may wait for the protocol support verification, as discussed above, and for a congestion report (CR) to be received. Once the protocol support verification is received, the UE may schedule transfer with a network entity, such as an eNB, in step 711. In step 712, an uplink transmission occurs in which the UE includes an application anticipated buffer status report (AA-BSR). The network entity may then provide a transfer plan report (TPR) in a downlink transmission to the UE, in step 713.

In certain embodiments, the UE may then go into a discontinuous reception (DRx) process or enter sleep mode, in step 714. The UE may then wait until either a bidirectional buffer congestion report (BCR) is received or a new cell is detected, as shown in step 715, in order to leave the discontinuous reception (DRx) process. In step 716, the UE may decide to complete a data transfer. A UE in the transfer mode or in a ready to go idle mode may then send a channel preference report (CPR) to a network entity, as shown in step 717.

In other embodiments, once the network entity provides a TPR in a downlink transmission to the UE, in step 713, the UE may transfer data, in step 718, or transfer data later and go idle, in step 719. A UE in the transfer mode or in a ready to go idle mode may then send a CPR to a network entity, as shown in step 717. In some other embodiments, the UE may transfer, as shown in step 718, or decide to transfer and go idle, as shown in step 719, after protocol support verification is received in step 710.

In step 720, the UE may receive a BCR with new congestion information. After receiving the BCR, the UE can, perform a transfer, wait in an idle mode, or schedule transfer with a network entity via AA-BSR, as shown in FIG. 7.

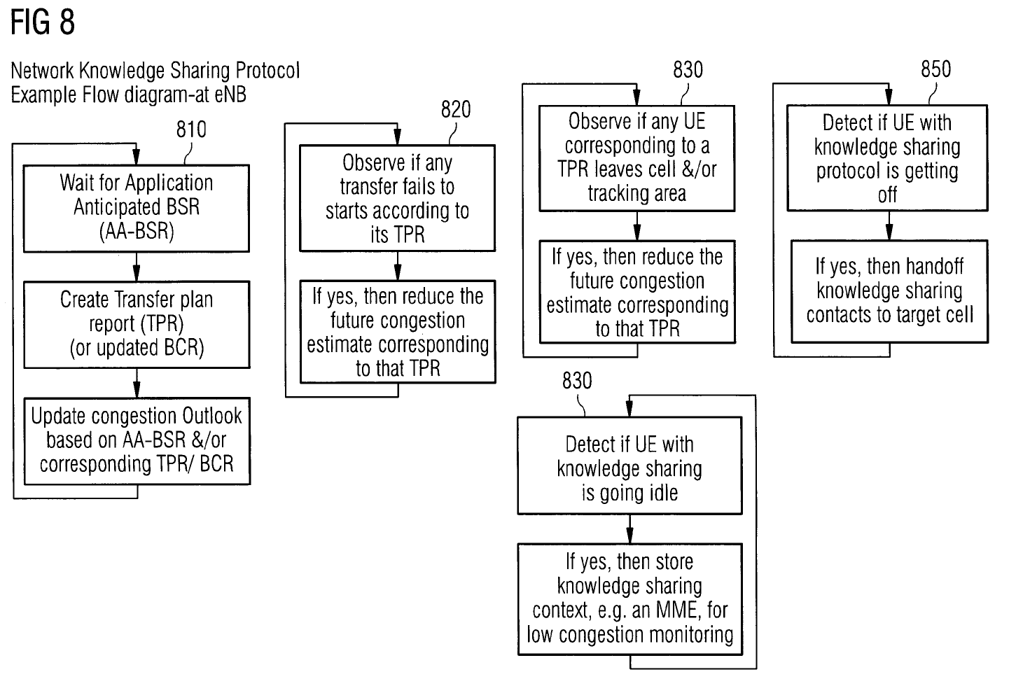

FIG. 8 illustrates an example flow diagram of the network knowledge sharing protocol according to certain embodiments. Specifically, FIG. 8 is an example of a knowledge sharing protocol flow at a network entity, such as an eNB. In step 810, the network entity may wait for AA-BSR, sent from the UE in step 712 in FIG. 7. The network entity may then create a TPR or update the BCR. Based on the AA-BSR, the TPR, and/or the updated BCR, the network entity may then update the congestion outlook or prediction.

In certain embodiments, the network entity may observe if any transfers to and/or from the network entity have failed to start according to the TPR, as shown in step 820. If a transfer has failed, the network entity may reduce the future congestion estimate corresponding to that TPR. In step 830, the network entity may observe if any UE corresponding to a TPR leaves the cell and/or a tracking area. If so, the network entity may reduce the future congestion estimate corresponding to that TPR.

In some embodiments, the network may detect if the UE that is part of the knowledge sharing protocol will enter an idle mode, as shown in step 840. If the UE does enter an idle mode, the network entity may store the knowledge sharing context, for example in an MME, for low congestion monitoring. In other embodiments, the network entity may detect if the UE with knowledge sharing protocol is being turned off or is moving to a new target cell, as shown in step 850. If so, the network entity may then handoff knowledge sharing information to a target cell.

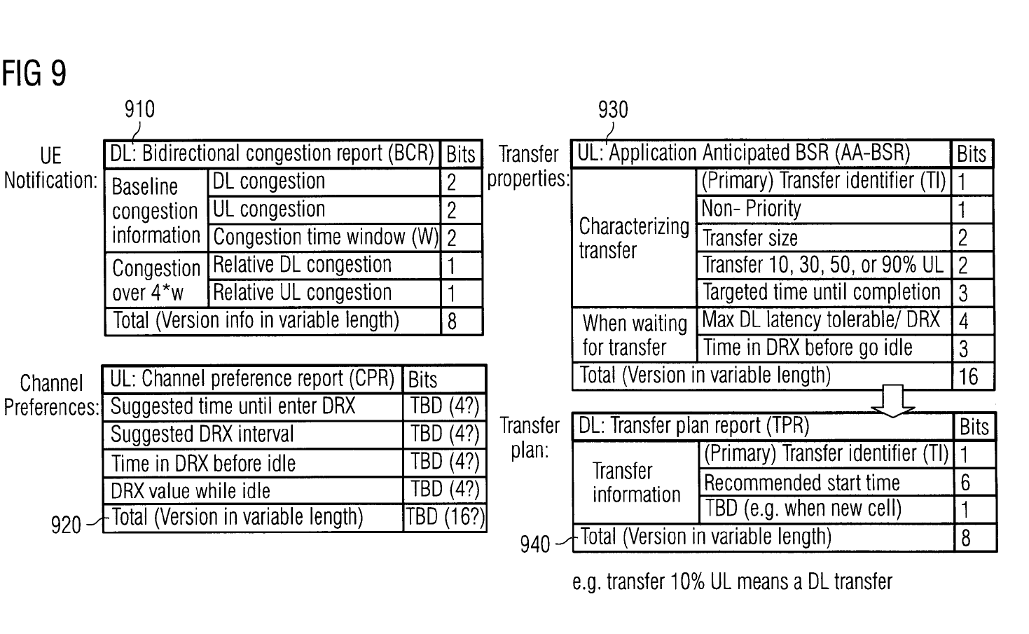

FIG. 9 illustrates a table according to certain embodiments. Specifically, FIG. 9 includes an exemplary downlink bidirectional congestion report 910, which is a user equipment notification. In addition, FIG. 9 also includes an example of an uplink channel preference report 920, an uplink AA-BSR 930, which describes transfer properties, and a downlink transfer plan report 940 received from the network entity, which describes a transfer plan.

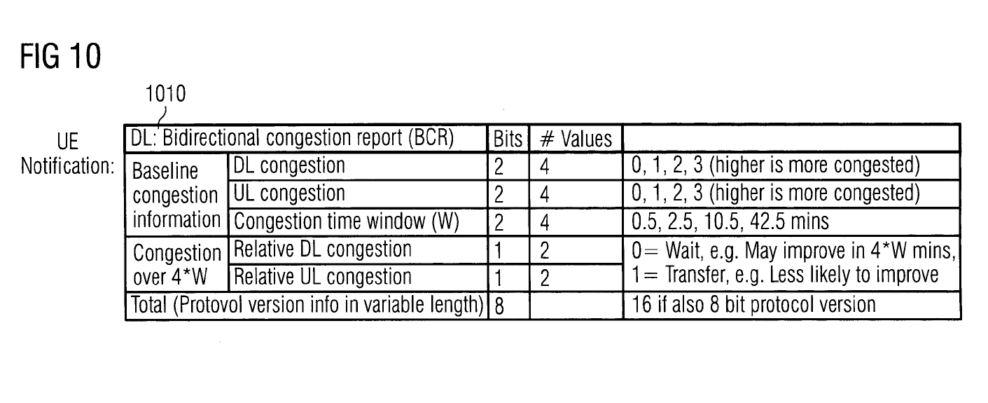

FIG. 10 illustrates a table according to certain embodiments. Specifically, FIG. 10 illustrates an example of a downlink bidirectional congestion report 1010. For example, the report can include baseline congestion information and congestion information over a specified congestion time window.

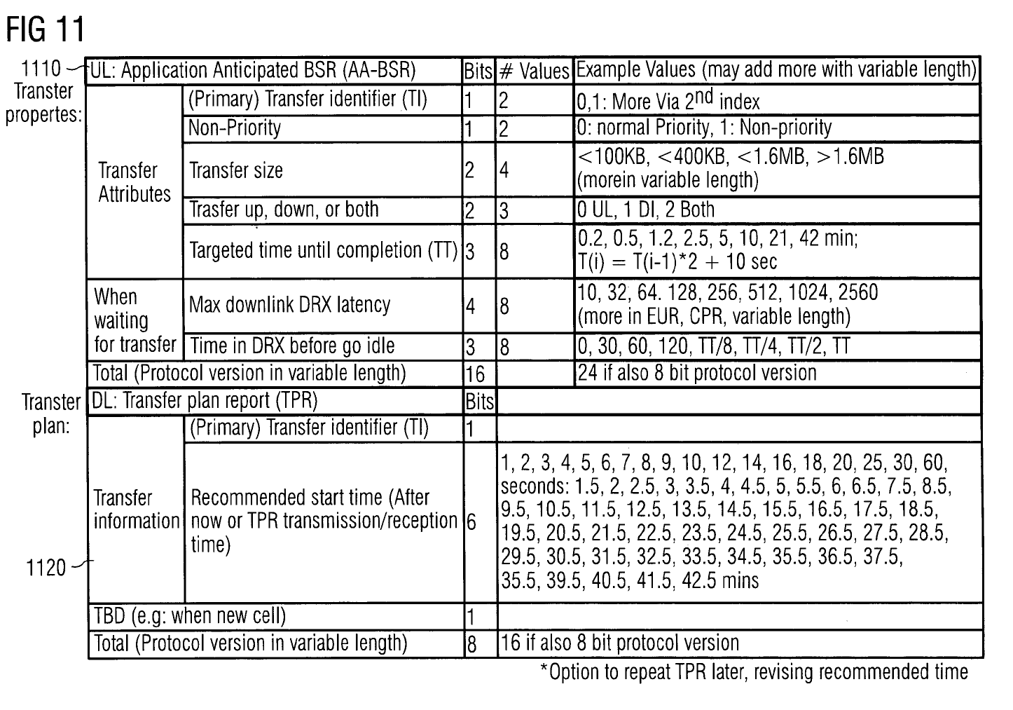

FIG. 11 illustrates a table according to certain embodiments. Specifically, FIG. 11 illustrates an example of an uplink anticipated BSR 1110. The BSR, for example, may include transfer attributes and waiting information. FIG. 11 also illustrates a downlink transfer plan report 1120 sent from the network entity to the UE, including transfer information.

In certain embodiments, the uplink knowledge sharing message can convey one or more specific information elements from the UE to the network entity. The information element may include an indication that a short inactivity timer is appropriate and/or an indication that a transfer by the UE is a background transfer or has a background status. The information, for example, may include an indication that a transfer is a future transfer or a current transfer. In certain other embodiments, the information element may include an indication that a background transfer has concluded, an indication of the volume of traffic expected over a next time interval, and/or an indication of an inactivity timer which is appropriate when the power preference indicator has a particular value.

In other embodiments, the information may be an indication of a DRX value, which may be appropriate when the power preference indicator has a particular value. The information may also include an indication of an inactivity timer which is appropriate when the UE is not using DRx. The indication can also include an inactivity timer which is appropriate when the UE is using a particular DRX configuration.

In some embodiments, the information can include an indication of one or more of a DRX and/or inactivity timer which can be used after an indicated transfer has completed. The transfer may be part of the knowledge sharing protocol. For example, some embodiments may allow for using a very short inactivity timer immediately after the conclusion of a transfer, where that inactivity timer is so short that it normally would disrupt the transfer itself. Because the knowledge sharing protocol may share the number of bytes associated with the transfer, the disruption of the transfer can be avoided while simultaneously allowing for the use of a very short inactivity timer and/or a very rapidly transitioning to idle mode. These embodiments can also avoid additional knowledge sharing message over the uplink at the conclusion of the transfer, to indicate that a very short inactivity timer is being requested at that time. The above embodiments can further avoid additional time and traffic processing, and improve capacity utilization.

In certain embodiments, the information elements may include an indication of a preferred configuration which may apply after the UE enters idle mode, such as a preference with respect to an idle mode DRx setting. The information elements may also include an indication of a future transfer by the UE. This indication may occur before the application bytes arrive into the (BSR) buffer. In other words, no BSR report would have been triggered yet. The information may also include an indication of the size associated with the future transfer. For example, the indication may correspond to the size of the transfer, and may separate listing of the uplink traffic versus the downlink traffic. The transfer size may be referred to in units of bytes, KB, MB, GB, or the like.

An indication of the direction or directions associated with the future transfer discussed above can also be included in some embodiments. For example, the indication may specify whether the transfer is substantially uplink only, downlink only, or bidirectional. There may be a separate bit, or field within the knowledge sharing message format, which indicates the values in the transfer field corresponding to an upload. The uplink knowledge sharing message may also include a request that the network entity notify the UE of major congestion changes relevant to its transfer attributes. For example, the indication may include a notification to the UE of low congestion, so that the UE may start transmission, or a notification to the UE of congestion, so that the UE can halt or pause transmission.

In addition, the uplink knowledge sharing message may include an indication of the intended start time of the transfer, and/or an indication of the maximum amount of time the transfer can be delayed. In addition, the message may include an indication of a maximum DRX value recommendation. The recommendation may include a maximum downlink notification latency over an upcoming interval, which may allow the network or network entity to make a more informed decision when configuring a longer DRX, while the UE can be in a connected state. An indication of the downlink notification latency preferred over an upcoming interval may also be included.

Certain embodiments may include an indication of the downlink notification latency requirement during the time interval between a present time and when the indicated transfer is expected to occur. An indication of the UEs expected mobility can also be included, and/or an indication of whether the UE can be expected to remain within the same cell, over a next time interval, such as between a present time period and when the transfer is expected to happen. Some embodiments can also include an indication of whether the UE expects to be in the same cell and/or location, during a specific time interval, for example, when the indicated transfer is expected or planned to happen. An indication of the time interval, during which the UE may expect to achieve a higher or highest signal strength or reference signal received power (RSRP) or reference signal received quality (RSRQ), may also be included.

Further, in certain embodiments, an indication that the UE has conveyed or received updated knowledge sharing protocol support to or from one or more additional network entities. For example, the network entity may be an application server associated with the UE operating system.

In embodiments in which the uplink knowledge sharing messaging can indicate that the background transfer has concluded, and/or the volume of traffic expected over the next time interval, the network or network entity can determine that it is more appropriate for the UE to immediately transition to an idle mode. Alternatively, the network or network entity can use this information to determine that a longer inactivity timer is appropriate, for example, where a large volume of traffic or a transfer is anticipated within a next short time interval. Typical values for inactivity timers may be between five to thirty seconds. In these embodiments, a wider range of values can be used, because of the deeper knowledge of the application state. These advantages described above may be derived from one or more other indications included in the uplink knowledge sharing message described above.

In certain embodiments in which the UE indicates the maximum downlink notification latency over an upcoming interval, this indication can allow the network or network entity to make a more informed decision in configuring a longer DRX, while the UE is still connected. This may allow the network and/or the UE to conserve resources while the subscriber continues to be connected. The UE can then stay in a connected mode while waiting for the network entity knowledge sharing protocol to deliver a downlink knowledge sharing notification to the UE indicating that a lower congestion interval has been reached.

Where the knowledge sharing messaging to or from the UE has indicated that a transfer will occur at a specific time interval starting in the future, it may be particularly helpful for the network entity to know the maximum downlink latency tolerable during this interval between now and when that transfer would occur. In this embodiment, the network entity can configure the longer DRx interval to be used during the waiting interval while waiting for that transfer to occur.

In other words, in the case of a background transfer, it may be that the UE will wait in a connected mode for an opportunistic, less congested opportunity to perform a transfer. In such an embodiment, the uplink messaging can indicate to the network entity that the UE would prefer a transfer within a given time range in the future, but that it does not expect to need significant and/or fast connectivity in the interim. For example, in the interim the subscriber may not actively use the device.

In response to this indication, the network entity can immediately place the UE in a connected mode discontinuous reception (C-DRX) mode with a long DRx interval, conserving the UEs battery while waiting for a reduction in the network congestion. When such a reduction in the network congestion is detected, the network entity can then transmit to the UE an indication that the network congestion has reduced, using a downlink knowledge sharing protocol message.

In certain embodiments, the uplink sharing message may include an indication of mobility and/or an idle state of the UE, as discussed above. By having the UE indicate to the network entity the expected mobility information of the UE, the network entity may estimate the future congestion within the cell, by combining the information of the UE indicated mobility, such as where the UE indicates that it is static, and where the UE has also indicated that it intends to perform a transfer within an upcoming time interval. The congestion estimate by the network entity may then be used to provide an indication over the knowledge sharing protocol to other UEs.

In some embodiments, the network entity using the indication of UE mobility over the protocol, may allow for better estimate of future congestion for performing load-balancing, admission control, impacting handoff, SON, energy savings decisions, and/or sharing with third-party applications.

Information regarding network congestion, including for example information related to call admission control (CAC), may help to better anticipate future network conditioned by utilizing knowledge derived from the knowledge sharing transfer reports generated by UEs. For example, the network entity may leverage the indicated transfer size and/or time, as well as low congestion notifications delivered to UEs. In some embodiments, the eNB may limit the number of low congestion notifications to the UE over a short interval. For example, each time the eNB transmits an indication over the knowledge sharing protocol to a UE indicating low congestion, there may be a probability that the UE can, in response, initiate a transfer. Consequently, the network congestion estimate may also be incrementally adjusted in response to the number of network initiated low congestion indications transmitted to UEs. The indications may in certain embodiments be recently transmitted indications. In one embodiment, the number of uncongested notifications can be limited to be no more than a threshold within a fixed time interval.

In certain embodiments the network congestion estimates can be further refined by knowledge of the inactivity timer settings and/or DRX settings requested by the UE over the knowledge sharing protocol.

However, in some embodiments, it may be that certain UEs, even after receiving the low congestion indication, continue to wait for the signal strength within that cell to continue to improve. The transfers initiated in response to the network initiated notification may take some time before being initiated. The UE can then balance the time before the transfer occurs with the likelihood that the network congestion will degrade over this time interval, potentially counteracting the benefits of the improved signal strength.

The congestion estimate may also be impacted by congestion in neighboring cells. For example, neighboring cell interference may impact the performance in an adjoining cell. The congestion estimate may also be impacted by an observation of the signal strength, for example, channel quality indicator (CQI), RSRP, and/or RSRQ associated with the UE, and/or the signal strength trend associated with the UE. The network entity can also use an estimate of the subscriber's mobility pattern, where the signal strength may be considered in providing congestion feedback to the subscriber when the subscriber has some mobility.

In contrast, when a subscriber is static then the signal strength can also be relatively static, such that signal strength may be a less relevant consideration in providing congestion feedback to that subscriber. In the case where the signal strength criteria discussed above may be utilized, a subscriber having a worse signal strength may receive a higher congestion estimate, under a cell with a given level of loading. When the loading level in that cell remains the same, and the subscriber has better signal strength, the subscriber may then receive a knowledge sharing message indicating that the congestion level is lower.

In another embodiment, the network entity may delay transmission of a notification over the knowledge sharing protocol. The delayed transmission may occur when the notification indicates low congestion, and when the network entity, for example eNB, detects and/or estimates that the signal strength associated with that particular UE appears to be improving.

The network congestion estimate may be distinctly different from the cell utilization, in certain embodiments. For example, the utilization within a cell may be quite high, but it may be that there is only a single UE operating in that cell. In this embodiment, the congestion in the cell may be relatively low, such that it may be appropriate that one or more additional subscribers utilize that cell for transfers. In this way, the network congestion estimate may incorporate a variety of factors including cell utilization, the number of active UE subscribers in that cell, and/or the types or priority of services being used by the UE subscribers.

In certain embodiment, when the UE indicates its own mobility information, the UE can enter idle mode while waiting for a lower congestion interval to perform the transfer. When a UE or mobile device enters idle mode, the UE conserves battery life and may not need to update the network when it moves from cell to cell within a larger group of cells known as a tracking area. However, by having the UE indicate that the UE expects to stay within the same cell over an upcoming time interval, for example, in an interval corresponding to an anticipated transfer, the network entity can monitor for low congestion intervals in the cell while the UE is idle. Additionally, the network entity can continue to anticipate that the UE transfer will occur in that cell, even though the UE has entered an idle mode, as discussed above.

Alternatively, when the UE indicates that the UE will follow a particular mobility trajectory or a higher mobility profile, then the network entity can perform the network congestion estimate, and/or monitor on behalf of the UE an anticipated transfer, in each of the upcoming UE locations and their corresponding cells. In an embodiment in which the UE is expected to be mobile, but the direction may not be known, the network congestion estimate may still be performed by looking at the average congestion in the neighboring cells.

In some embodiments, the UE may indicate that it will exit the cell within an upcoming time interval. The network entity can use knowledge of the relative congestion in one or more neighboring cells to determine whether to indicate low congestion during the interval prior to the UEs anticipated exit from that cell. The low congestion indication can be transmitted over the knowledge sharing messaging to the UE. In other embodiments, where there is no explicit indication of neighboring cell congestion, but rather the normal congestion indication field over the knowledge sharing protocol may convey a different congestion value, that value may correspond to the anticipated congestion based on the estimated UE mobility.

The UE, in certain embodiments, can also indicate the mobility plans of the UE, such that if the UE goes idle, even though it may have previously indicated that it was going to stay static, the UE may provide an indication to the network entity. The network entity can then assume that the UE is likely still on the same cell, and is waiting for a low congestion indication. Alternatively, the same scheme could apply when the UE can provide the network entity with a list of the cells that it expects to traverse at specific times. This information can then be tracked by the network entity and/or the MME even though the UE is idle. The information may then be used to perform a downlink notification opportunistically based on the network entity congestion.

In a further embodiment, when the UE is idle, upon transitioning to a new cell, the UE may initiate connecting to the network, and retrieve the information from the knowledge sharing protocol, such that it can determine immediately if that cell is relatively uncongested. In such an embodiment, if the cell is relatively uncongested, the UE may immediately initiate the background transfer.

In certain embodiments, the UE may indicate that the planned or current transfer is a background transfer. The indication may allow the network entity to determine whether to use a lower priority scheduling with a transfer, when performing resource allocation within the network entity. Additionally, this indication can allow the network entity to determine that a transmission may be cancelled or delayed. The transfer may be cancelled or delayed when another UE subsequently requests a non-background transfer through the knowledge sharing protocol, and where the two transfers would otherwise conflict and occur at the same time.

When the UE enters idle mode, in some embodiments, providing the network entity with an indication that the UE is entering an idle mode may allow the network entity to leverage one or more network entities, possibly including the MME and/or the serving gateway. Once a UE enters idle mode, the network entity may release the context information associated with that UE. When the UE enters idle mode, a portion of the knowledge sharing context information may be included in the UE context information that is transmitted from a network entity, such as an eNB, to the MME. This context information may include an indication of the anticipated transfers and/or other attributes associated with that UE.

In certain embodiments, an MME, or any other network entity, may monitor the congestion level in one or more cells. When the MME, or another network entity, detects low congestion in a cell corresponding to the UE context, the MME may cause the UE to be paged. The detected low congestion may be based on, for example, the UEs anticipated uplink or downlink transmission, and/or mobility information from the knowledge sharing protocol. In such an embodiment, the UE may not actually receive any bearer path traffic, but upon being paged, the knowledge sharing protocol may automatically allow the UE to discover that the current congestion in that cell is low. This may allow the UE to initiate the transfer, planned over the knowledge sharing protocol, at an opportunistic time, as determined by the UE.

In certain embodiments, the network node can use the UE reported information, for example, about an anticipated transfer, transfer time, and/or transfer timescale, to estimate the congestion timescale of interest to the UE. For example, if the UE indicates that it has a transfer which needs to be completed in the next 30 seconds, the network entity can be triggered to provide a relatively short timescale congestion estimate, such as an estimate corresponding to the congestion observed over the most recent 30 seconds. In contrast, if the UE indicates a transfer that needs to be completed in the next five minutes, then the network entity can be triggered to provide a relatively long timescale congestion estimate. The long timescale congestion estimate can correspond to the congestion observed over the most recent five minutes.

The knowledge sharing protocol can also, in some embodiment, be used to reduce the amount of downlink knowledge sharing messaging sent from the network entity, for example an eNB. This reduction may be achieved by having the network entity estimate the transfer direction and timescale information of interest to the UE, by observing the UE traffic. The first knowledge sharing message can use the estimated transfer direction and timescale information to avoid sending a second downlink knowledge sharing message.

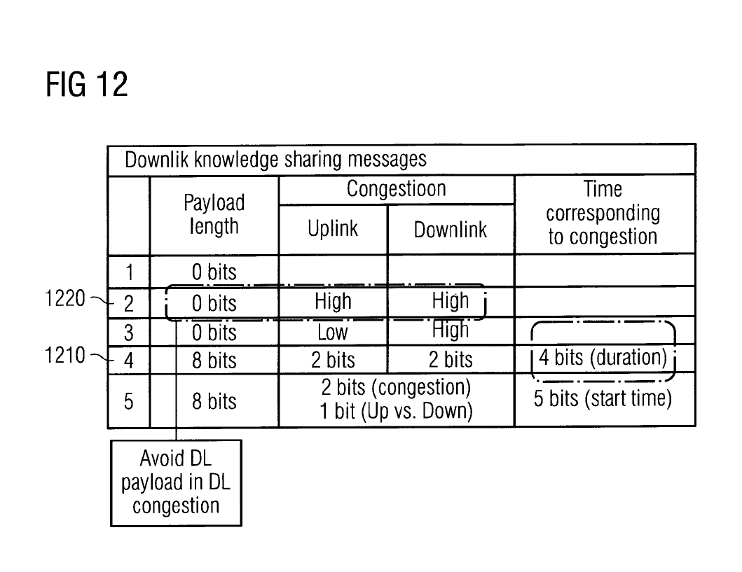

FIG. 12 illustrates a table according to certain embodiments. In particular, FIG. 12 illustrates a table of downlink knowledge sharing messages. Each message may contain information, such as payload length, uplink congestion, downlink congestion, and/or the time corresponding to the congestion. For example, message 1210 illustrates the fourth downlink knowledge sharing message. Message 1210 indicates a payload length of 8 bits, indicates that the congestion of the uplink and downlink congestion is both 2 bits, and also indicates that the time corresponding to the congestion is 4 bits.

Message 1220, on the other hand, illustrates that second downlink knowledge sharing message. Because the congestion of the downlink is high, the network entity may avoid a downlink payload. The payload length of message 1220 is therefore indicated as having 0 bits.

The downlink knowledge sharing messaging can convey one or more specific information elements to a network entity. These information elements may be sent by the network entity to indicate to the user equipment that the user equipment should perform an action specific to the data delivery.

Certain embodiments may include information elements relating to a short-term or long-term congestion, on one or more of the uplink channels, and/or the downlink channels. The information elements may also include information elements about short-term or long-term congestion across uplink and/or downlink channels. The congestion information element, for example, may be a unitless number between one and eight that can be used to indicate the congestion state associated with whichever of the two link directions, uplink or downlink, is more congested. This congestion estimate can correspond to a planned bidirectional transfer.

Some embodiments may include an indication of the congestion over alternate wireless technologies, for example WLAN. An indication of the timescale or cells associated with the congestion estimate provided may also be included. For example, the indication of the timescale may be associated with the long-term congestion estimate provided over the knowledge sharing protocol.

In yet another embodiment, the downlink knowledge sharing messaging can convey may include an indication of a mobility congestion estimate. The estimate may indicate the likely congestion that the UE can encounter if the UE is mobile, as opposed to a congestion estimate which may be expected by the UE when the UE remains relatively static or in the same location. The determination of whether the UE is mobile may be based on one or more neighbor cells, or any other likely handoff cells. The information element may also include an indication of a recommended time for a transfer. The recommended time may be within a specific time window indicated by the UE.

The information element may also include an indication of the transfer direction associated with the recommended time for the transfer. An indication of a recommended transfer size, which may be represented in bytes and/or seconds, associated with the recommended time for the transfer may also be included. This indication may be helpful where the UE has requested or indicated that it plans on initiating a particularly large transfer, but the network has identified a smaller uncongested opportunity and has recommended that the UE perform a fraction of the planned transfer during this opportunistic interval.

Certain embodiments may include an indication that the recommended time for a transfer corresponds to the anticipated transfer indicated by the UE in the uplink knowledge sharing protocol. The information element may also include an indication of the congestion in the cell resulting from a particular category of UEs. For example, the congestion in the cell may result from UEs from a particular provider or vendor. Alternatively, the congestion may correspond to UE subscribers which support the knowledge sharing protocol.

In addition, the information element may include an indication of congestion in one or more other cells, such as neighboring cells. The indication may also be an explicit indication of the congestion in an overlay macro cell. An indication of the congestion in an overlay macro cell may be relevant, for example, where a UE is under a small cell, which is in the middle of the coverage area of a macrocell, and the UE may have has some mobility capabilities.

In certain embodiments, the downlink knowledge sharing message may include an indication of the subscriber experience, such as a quality of experience (QoE), corresponding to the experience of the lowest quality subscriber experience in that cell. The subscriber may be from a particular category of subscribers, such as from a particular UE provider or vendor, or among the UEs using the knowledge sharing protocol in that cell or geographic region.

An indication of the likely sensitivity of the subscriber throughput to the signal strength at the UE may also be included. This provides a parameter that allows the UE to estimate a multiplicative change in the likely throughput achieved as the signal strength, RSRP or RSRQ, changes as the UE moves within that cell, while the cell has a constant level of congestion. In other words, the subscriber can use this parameter within a predetermined function to estimate the degree to which changes in signal strength will correlate with faster or slower transmission opportunities, even when the cell has a constant level of congestion.

The downlink knowledge sharing message may convey one or more specific information element including an indication of the radio resource control (RRC) inactivity timer value that a network entity currently plans to use for the UE. The information element can also indicate the network entity vendor type and/or knowledge sharing protocol version. In some embodiments, an indication can include a message that the UE should wait in an idle mode until it enters another cell. Once it enters the other cell, the UE may connect to the new cell, and determine the current congestion using the knowledge sharing protocol. This indication may further indicate specific neighboring cells, for example, neighboring cells which have lower congestion, where the UE should use this approach.

In certain embodiments, the downlink knowledge sharing message may include an indication of the type of neighboring cells where the subscriber should subsequently attempt to connect in order to determine the congestion level. For example, the UE subscriber may connect to the specified cells in order to determine the congestion level over the knowledge sharing protocol, or cells of a particular type, such as small cells, femto cells, and/or macro cells.

In addition, the message may include an indication that specific neighboring cells support the knowledge sharing protocol. The indication may also include cell names or associated cell broadcast information which will allow the UE to identify at a later point in time that the UE may be near a specific cell. An indication can also include a notification that the knowledge sharing protocol support at that cell is ending shortly. For example, the indication may be a time interval after which the protocol support information should be deleted from the UE and/or the UE operating system or ecosystem may be included.

An indication can also include instructions to the UE for how to estimate the downlink cell congestion from RSRQ. For example, the instructions may detail how the UE can compensate for the level of other cell interference being received in that approximate location. An indication to the UE may also include, in some embodiments, instructions for how to estimate the uplink cell congestion from a modulation coding sequence (MCS) assigned as a part of uplink grant.

In addition, the downlink knowledge sharing message may include an indication of the degree to which the UE can generate knowledge sharing protocol messaging over the uplink. The indication may prohibit the UEs from transmitting long uplink knowledge sharing messages when the uplink buffer is congested. This embodiment may also be implicit, meaning that the UE may automatically determine that it is disallowed from transmitting one or more uplink knowledge sharing messages after the UE receives a message from the network indicating that the uplink is congested. In addition, while in certain embodiments all uplink knowledge sharing messaging, the indication may still allow for downlink knowledge sharing messaging.

Alternatively, in certain embodiments, the UE may perform messaging which indicates planned transfers, but which does not allow for providing knowledge sharing inputs relating to network configurations, such as inactivity timer and/or DRx. Conversely, certain embodiments may allow the UE to provide inputs with respect to the inactivity timer and/or the DRx, but may not allow inputs with respect to planned transfers.

The network may configure the downlink indication to optimize the network performance, while considering the overhead generated by the uplink knowledge sharing messaging, and/or the observed benefits generated by the knowledge sharing messaging. The network may also disallow, in certain embodiments, the uplink knowledge sharing messaging from a subset of the UE devices where, for example, the benefit of such messaging is expected to be smaller. Other embodiments may disallow the uplink knowledge sharing messaging for UEs that tend to generate less traffic, or where the UE power preference indicator indicates that performance is more important than conserving power.

In certain embodiments, the downlink knowledge sharing indications can allow the UE to determine whether a given time period is a good time to initiate, continue, and/or stop data delivery or an application transfer exchange with the network entity. The UE may combine its knowledge of the transfer attributes with those of the network congestion, for example, the network congestion timescale, to determine whether and when to initiate a transfer.

Additionally, in certain embodiments, the knowledge sharing protocol may use connected DRX, to enable the subscriber to save battery life while staying in connected mode, and while waiting for an opportunistic notification of a low congestion event.

In certain embodiments, the UE may use a received indication of the RRC or idle inactivity timer value, which is currently planned to be used by the network for the UE, in order to minimize the amount of additional signaling required. This received indication may allow the UE to avoid transitioning to idle mode. For example, the UE can wait until prior to or just prior to the inactivity timer expiration before initiating bearer traffic necessary to maintain the subscribers connected state. The UE may then continue to wait for a knowledge sharing low congestion notification without necessarily having to transmit uplink knowledge sharing messaging to the network entity, requesting an explicit extension to the RRC inactivity timer.

Additionally, the duration of the suggested inactivity timer can be indicated over the knowledge sharing protocol to the UE. The duration of the inactivity time may be relative to a time associated with an anticipated transfer. For example, the suggested timer may indicate that the inactivity timer may be sent during a specific fraction of the time until the planned transfer. The inactivity timer field values may indicate that the inactivity timer can equal a hundred percent, one half, one fourth, or ⅛ of the maximum time until the planned transfer. In this way, the UE can remain in a connected state for a time period until the transfer.

In certain other embodiments, the UE can use the knowledge of the current RRC inactivity timer to efficiently convey the relative change in the inactivity timer which the UE prefers. For example, in the uplink knowledge sharing message, the UE can indicate a value to indicate that an inactivity timer that is longer than the current or proposed inactivity timer value is preferred. The value may be conveyed in a particular field of the knowledge sharing message.

In contrast, a different value, which may be included in the same knowledge sharing message field, may indicate that a shorter inactivity timer is preferred by the UE. A shorter inactivity timer may mean that the timer can be shorter than the currently proposed or currently used value.

In certain embodiments, a downlink indication of a network entity performance may be specific to UEs of a particular type, such as those UEs which subscribe to a particular provider. When the knowledge sharing protocol sends a downlink congestion notification to the UE, the network entity may indicate to the UEs of a particular type that the network is congested. The network entity may also indicate that a UE is located in an area having a large density of subscribers supporting knowledge sharing, and/or a large density of subscribers from a particular device vendor within that cell. Such embodiments may allow a UE to withdraw its transmission if there are other UEs devices from a similar provider in the cell.

As discussed above, in certain embodiments UE throughput and/or effective congestion levels may be expressed as functions of signal strength. In such embodiments, the network entity may provide the UE with a parameter to allow the UE to estimate the multiplicative change in the likely throughput it would achieve, as it moves further away from the cell. The estimation of the UE may capture the degree to which the scheduler is biased towards providing higher data rates to the subscribers which are closer to the cell. For example, the multiplicative change in throughput may be a function of RSRP for a given congestion level.

In some embodiments, the UE can use the anticipated mobility and/or anticipated signal strength to calculate a maximum signal strength interval where a transfer can occur. The UE can also determine the timing of this maximum signal strength time interval, and communicate over the knowledge sharing protocol the time interval corresponding to the maximum signal strength time interval, which may be calculated as discussed above.

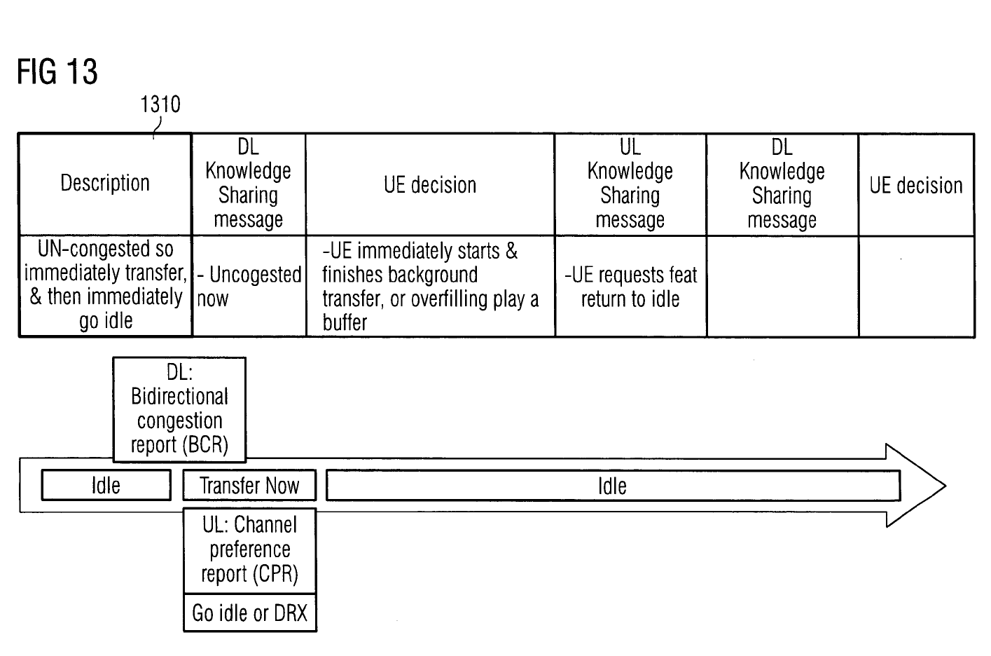

FIG. 13 illustrates an example use case according to certain embodiments. Specifically, FIG. 13 illustrates an example of a network knowledge sharing protocol in which an immediate transfer may be initiated, when starting a new connection or after a handoff. Table 1310 illustrates an un-congested network scenario which may warrant an immediate transfer, followed by a return to an idle state. The downlink knowledge sharing message from the network entity to the UE may indicate that the network is not congested. The UE can then use this downlink information to start and finish a background transfer, or to overfill the play buffer. The UE can then request a return to idle in an uplink knowledge sharing message.

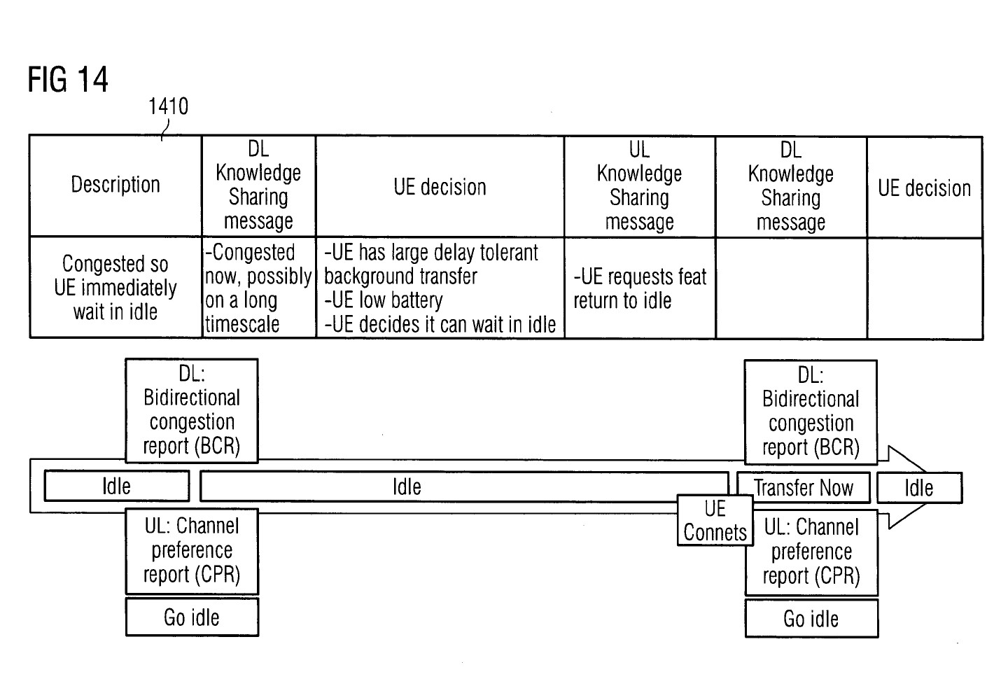

FIG. 14 illustrates an example use case according to certain embodiments. Specifically, FIG. 14 illustrates an example of a network knowledge sharing protocol in which an immediate return to idle may be initiated, when starting a new connection or after a handoff. Table 1410 illustrates a congested network scenario which may warrant an immediate return to idle, followed by a return to an idle state. The downlink knowledge sharing message from the network entity to the UE may indicate that the network is congested, and may be so for a long timescale. The UE can then use this downlink information to decide to wait in idle, which can help save the UE battery. The UE can then request a return to idle in an uplink knowledge sharing message.

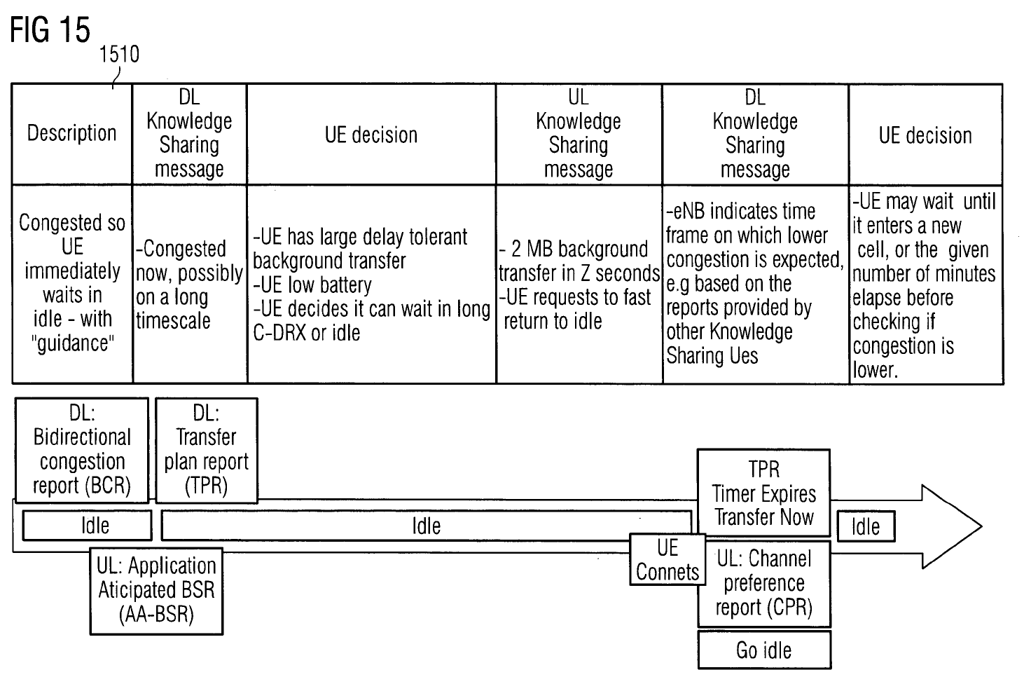

FIG. 15 illustrates an example use case according to certain embodiments. Specifically, FIG. 15 illustrates an example of a network knowledge sharing protocol in which an anticipated transfer can be scheduled, when starting a new connection or after a handoff. Table 1510 illustrates a congested network scenario which may warrant the UE waiting in idle, with guidance. The downlink knowledge sharing message from the network entity to the UE may indicate that the network is congested, and may be so for a long timescale. The UE can then use this downlink information to decide to wait in long C-DRX or in idle mode. The UE can then request a background transfer, such as a two megabyte background transfer in a given period of time, and a return to idle in an uplink knowledge sharing message.

The network entity may also indicate a time frame on which lower congestion is expected, based on reports provided by other knowledge sharing UEs, for example. The UE may decide to wait until it enters a new cell, or decide to wait for a given period of time before checking if the network congestion is lower.

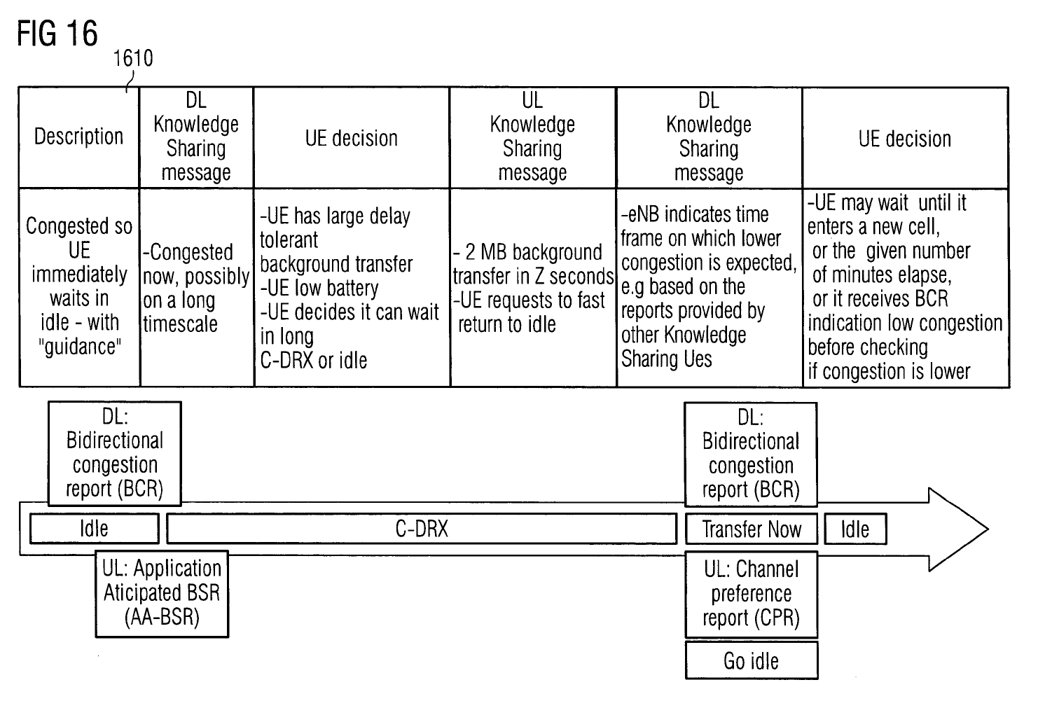

FIG. 16 illustrates an example use case according to certain embodiments. Specifically, FIG. 16 illustrates an example of a network knowledge sharing protocol in which an anticipated transfer can be scheduled, when starting a new connection or after a handoff. Table 1610 in FIG. 16 is similar to table 1510 in FIG. 15. In FIG. 16, however, the UE may decide to wait until it receives a BCR indication from the network entity indicating low congestion before initiating a transmission.

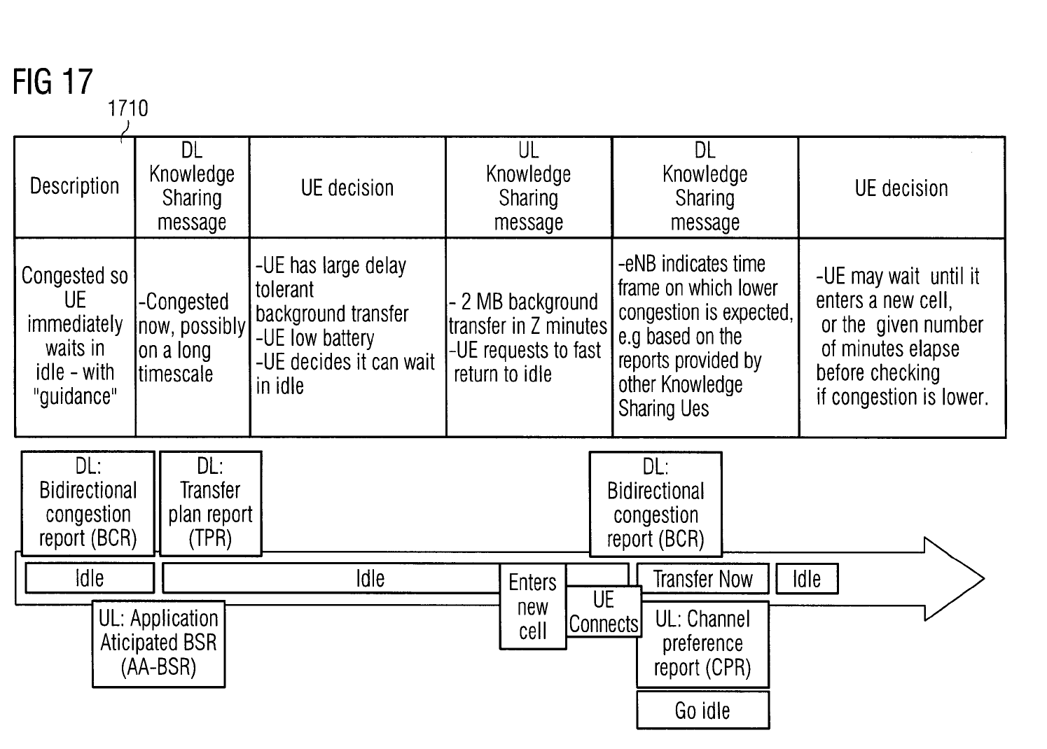

FIG. 17 illustrates an example use case according to certain embodiments. In particular, FIG. 17 illustrates an example of a network knowledge sharing protocol in which a low congestion is determined in a new cell, when starting a new connection or after a handoff. Table 1710 may be similar to table 1510 in FIG. 15, except the UE enters and connects to a new cell.

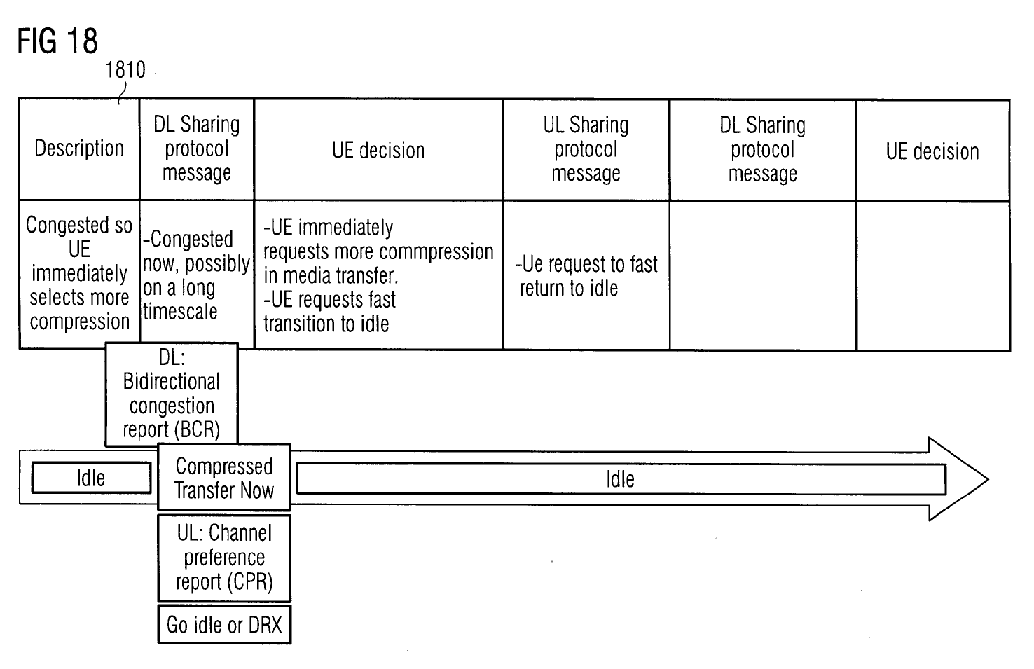

FIG. 18 illustrates an example use case according to certain embodiments. Specifically, FIG. 18 illustrates an example of a network knowledge sharing protocol in which compression selection may occur prior to initiating an anticipated transfer. Table 1810 illustrates a congested network scenario where the UE immediately may select more compression. The downlink knowledge sharing message from the network entity to the UE may indicate that the network is congested. The UE can then use this downlink information to request more compression in media transfer and/or a fast transition to an idle state. The UE can then request a return to the idle state in an uplink knowledge sharing message.

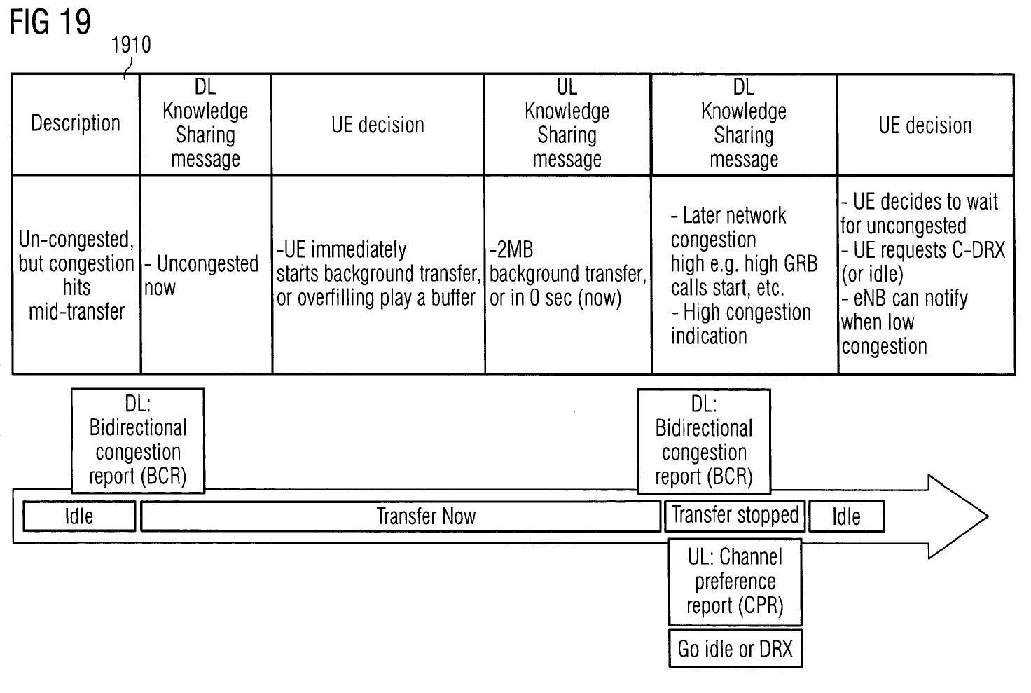

FIG. 19 illustrates an example use case according to certain embodiments. Specifically, FIG. 19 illustrates an example of a network knowledge sharing protocol in which a transfer may be quickly paused by a high congestion notification. Scenario 1910 illustrates a non-congested network in which congestion occurs during a transfer. The downlink knowledge sharing message from the network entity to the UE may indicate that the network is uncongested. The UE can use this downlink information to start a background transfer and/or to overfill the play buffer.

The UE can then receive a downlink knowledge sharing message indicating that the congestion is high. The UE may decide to wait for a non-congested period of time, and/or request C-DRX or to enter idle mode. The network entity can then notify the UE when congestion is low.

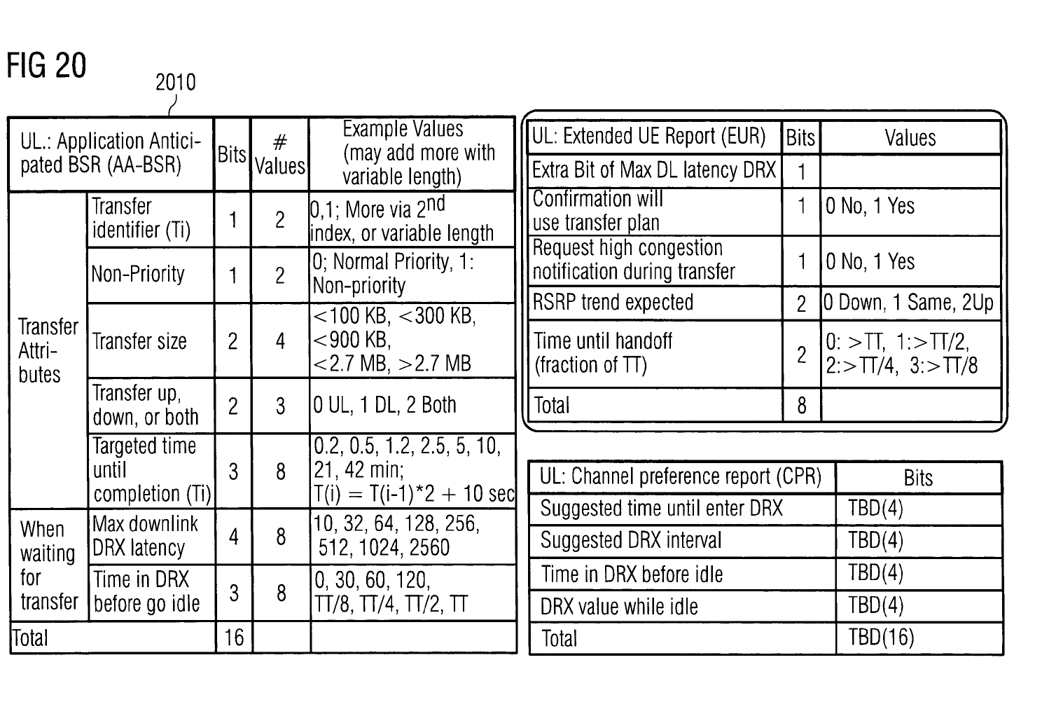

FIG. 20 illustrates an example of a table according to certain embodiments. In particular, FIG. 20 shows an embodiment of extended uplink messaging 2010, including an AA-BSR, an extended UE report, and a channel preference report.

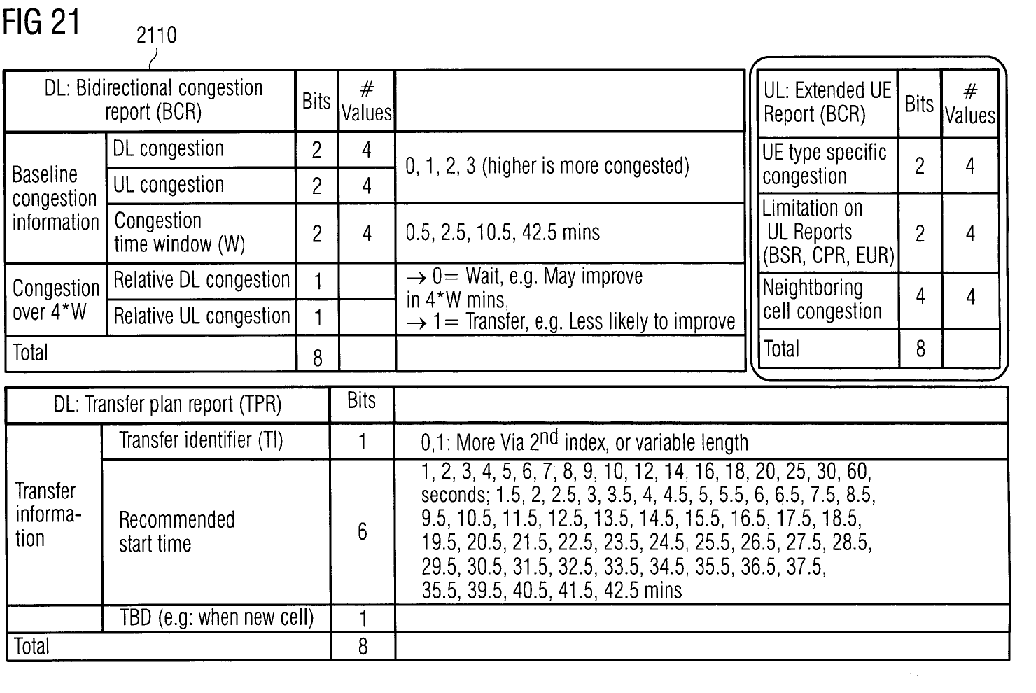

FIG. 21 illustrates an example of a table according to certain embodiments. In particular, FIG. 21 shows an embodiment of extended downlink messaging 2110, including a bidirectional congestion report, an extended congestion report, and a transfer plan report.

In certain embodiments, the knowledge sharing protocol may use one or more reserved indexes within the MAC CE message on the uplink transmission and/or downlink transmission. The attributes of the knowledge sharing message format may include either short or zero payload lengths that can be used to convey a state of the network congestion in the link direction conveying the knowledge sharing message. For example, given that the congestion information is conveyed by the knowledge sharing protocol on the downlink, one or more messages indicating heavy congestion of the downlink may be given a separate index, or may be structured with a variable payload length. The knowledge sharing congested message can have a zero or a short payload length, as shown in FIG. 9. In some embodiments, for example the embodiment shown in FIG. 21, longer messages can be used to convey a variety of other network entity information scenarios, such as providing support for conveying lower congestion state scenarios on the downlink.

Separate fields may be used to indicate the recommended time of a transfer, as opposed to the timescale associated with a congestion estimate. The two different fields both relate to time, but can convey different information to the UE. The recommended time of the transfer may recommend when the UE should perform a transfer. The recommended time of transfer may be referred to as a lease congestion indication report. On the other hand, the timescale field may indicate that a congestion estimate is, for example, a short-term timescale and may likely be most relevant over the next 30 seconds. Alternatively, the timescale field may indicate that a better congestion estimate of the most likely conditions may be over the next five minutes. In other words, the better congestion estimate may come from a longer timescale congestion estimate, gathered over approximately the last five minutes, for example.

In certain embodiments, the attributes of the knowledge sharing message format may include a power preference indicator (PPI) defined in 3GPP, to change the interpretation of specific fields within the knowledge sharing message format. For example, PPI may be used to change the interpretation of a knowledge sharing field such as a DRx and/or an inactivity related field. The message may also use a single field to convey DRx and/or inactivity timer settings. In such an embodiment, it may be possible to signal only specific combinations of the C-DRX and the inactivity timer.

The message may also use a single field to indicate that a planned or current transfer is a background transfer. In addition, the field may be used for the UE preference to automatically transition to idle mode at the end of the background transfer. In such an embodiment, it is relatively unlikely that additional data activity may be required at the end of the background transfer because the subscriber is not interacting with their UE or device. In one example, the device may be in the subscriber's pocket.

The message may use knowledge of the present quality of service (QoS) channel indicator (QCI) as defined within 3GPP and/or a highest priority QCI to change the interpretation of one or more fields within the knowledge sharing protocol. For example, the protocol may support changing the interpretation of the field conveying DRx related information, such that different DRx values can be implied in the context of different highest priority QCI values. If the QCI indicates a low latency service is currently present, then the DRx field may indicate one of multiple DRx values which are relatively short. On the other hand, if the QCI indicates that there is not a low latency service currently available, then the values may be interpreted to indicate which of a number of different longer DRx values may be appropriate.

In certain embodiments, the UE may as part of the knowledge sharing protocol report potential or anticipated transfers, and convey such potential or anticipated transfers over application anticipated BSR, or informational BSRs.

It is possible, in certain embodiments, to avoid the knowledge sharing protocol verification mechanism, after handoff to another cell under the same network entity, such as an eNB. While the UE may not be able to tell when it is handed off to another cell under the same eNB, the eNB can be aware of the handover. In such embodiments, the eNB can use its knowledge that the UE supports the knowledge sharing protocol, from the previous cell, and continue the knowledge sharing protocol with the UE. For example, the eNB may watch for a low congestion condition, and not transmit a protocol confirmation message to the UE, until such a low congestion condition can be detected. As such, additional protocol confirmation messaging can be avoided.

The retained knowledge by the eNB that the UE supports the knowledge sharing protocol can also reduce knowledge sharing messaging sent from the eNB, which can help to reduce overhead. The eNB may send an explicit watch indication in an uplink and/or downlink knowledge sharing messaging. The knowledge sharing protocol can explicitly supervise the creation, maintenance, and/or deletion of the watch indication. For example, the creation, maintenance, and/or deletion of the watch indication may depend on when or where the UE would like to receive a notification that the congestion has increased or decreased, and for how long. In addition, the creation, maintenance, and/or deletion of the watch indication may depend on whether a particular event happens during an ongoing transfer, prior to the transfer starting, or while the UE is in C-DRX.

In one embodiment, the UE may already be receiving downlink transmissions, and by providing this watch indication the subscriber would presumably be enabled to stop performing the transfer quicker than would otherwise be the case. This may help a UE measure link speed during the transfer, and can save the UE time in having to discover the congestion. For example, it may take the UE an extra 20 seconds to discover that the congestion has increased and react. In the above embodiment, however, the UE may be able to stop performing the transfer quickly.

In addition, the knowledge sharing protocol information may be handed off, from the one eNB to the next. The network may support handing off the knowledge sharing protocol information, such that the receiving network entity, such as an eNB, can be aware that a particular UE not only supports the knowledge sharing protocol, but also has knowledge of what are the planned transfers, previously indicated to the eNB over the knowledge sharing protocol.

If knowledge sharing context handoff is performed, the initial downlink knowledge sharing message can use the network information most relevant to that UE or subscriber, based on the needs or wants of that particular subscriber. For example, the target eNB may use its knowledge that the UE is waiting to be notified of a low congestion opportunity on the uplink, and after handoff that eNB may hold off on doing a downlink message, until it observes low congestion on the uplink. In other words, the network entity may be aware that the subscriber is waiting for a low congestion opportunity, and may wait until such opportunity is noticed before it triggers a transfer.

In certain embodiments, upon handoff the eNB can handoff knowledge sharing context and/or potentially indicate to the target cell the knowledge sharing context. Such context may include, for example, pending knowledge sharing transfers and/or knowledge sharing responsiveness. The eNB may also potentially share with the target cell that the knowledge sharing context can support multivendor handoff. In addition, if the eNB is waiting to notify the UE of low congestion, it may avoid transmitting a downlink message to the UE, until low congestion is detected.

The network entity, in some embodiments, may estimate knowledge sharing information of interest to the UE. When the UE is initially connected or after a handoff, and the UE may receive a knowledge sharing message from the UE. The UE may then convey planned transfer information over the knowledge sharing protocol. The conveyed planned transfer information may include a request for a longer knowledge sharing congestion report matching the planned transfer attributes. The conveyed planned transfer information may also include information allowing the network entity to use its transfer attributes in generating future congestion reports, or a request to the network entity to notify the UE of major congestion changes that can be relevant to its transfer attributes.

In certain embodiments, in which the UE is returning from idle mode, and it is still under the same cell with which it was recently connected, which has already confirmed that the eNB supports the knowledge sharing protocol, the UE may go ahead and transmit the knowledge sharing protocol message up to the network entity in the cell. The UE may do so because it was able to retain or remember the knowledge that the cell is capable of receiving a knowledge sharing protocol message. This embodiment can avoid having to send a downlink message from the network entity in the cell to confirm that the cell supports the protocol.

When the UE is returning from an idle mode to an active mode within the same cell, the network entity, such as an eNB, may in certain embodiments not be able to determine that the UE subscriber is the same subscriber with which they previously communicated. This may be caused, for example, by the use of a temporary UE identifier. However, the UE may still know that it is communicating with the same cell, which had previously supported the knowledge sharing protocol. Consequently, even if the network entity does not transmit a knowledge sharing protocol message on the downlink, the UE may still transmit knowledge server messaging on the uplink. After the UE transmits a knowledge sharing message, the eNB may then determine that the UE knows that knowledge sharing is supported, and deduce that the cell can avoid transmitting a knowledge sharing protocol on the downlink.

In certain embodiments, in response to receiving a knowledge sharing message, the UE may evaluate the urgency of its transfer, and decide whether to continue, temporarily delay, for example, C-DRX, or significantly delay the transfer by entering idle mode. The UE may act on its decision by initiating a transfer and/or requesting to enter either C-DRX or idle mode over the knowledge sharing protocol.

In some embodiments, the UE may use the information received over knowledge sharing to determine whether to utilize an alternate wireless technology such as WLAN or not. For example, if the knowledge sharing protocol indicates that the eNB is relatively uncongested, the UE may determine that it can save battery life by connecting over the eNB. In contrast, if the knowledge sharing protocol indicates that the eNB is relatively congested, the UE may connect through a WLAN access point, such as an un-trusted WLAN access point within a subscriber's home. In some embodiments, the network entity may indicate to the UE over the knowledge sharing protocol whether the UE should utilize a WLAN access point, as opposed to a cellular access point.

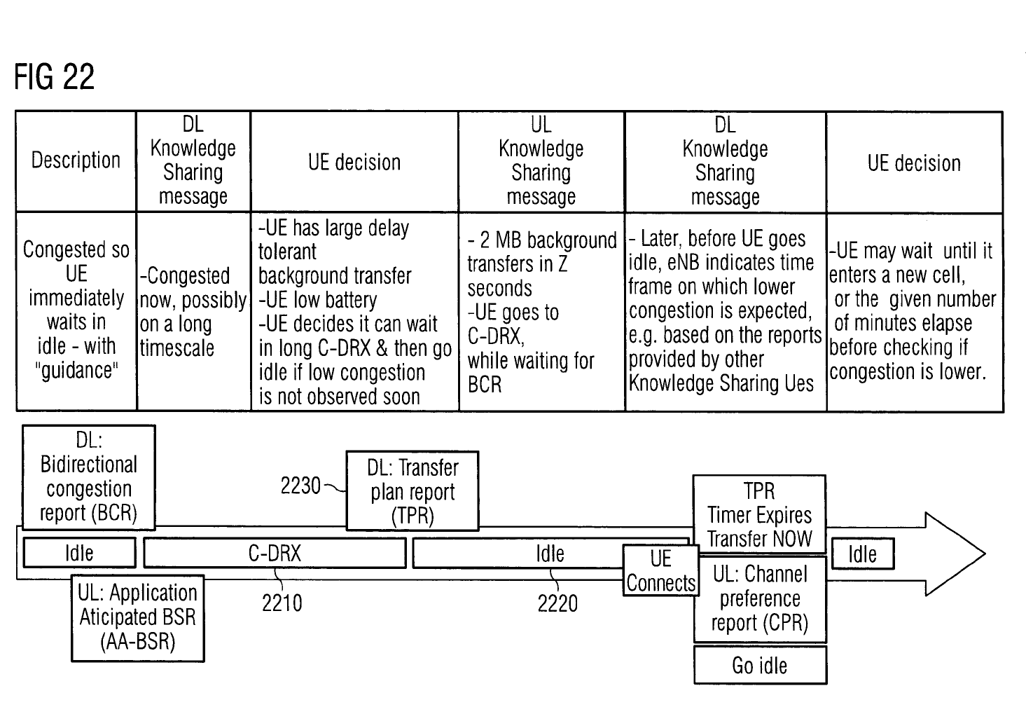

FIG. 22 illustrates an example use case according to certain embodiments. In particular, it may be that a UE initially waits in C-DRX, as shown in step 2210 for a low congestion notification. After some interval of time though, if no such notification has been received, it may be appropriate to transition to idle mode, as shown in step 2220. At this point the eNB network knowledge sharing protocol may initiate transmitting a transfer plan report (TPR) to the UE, as shown in step 2230, providing guidance on what would be the most appropriate time to initiate the transfer from idle. This is done such that the UE TPR can leverage the most recent network congestion information, just prior to it losing connectivity. However, prior to the UE going idle, the network knowledge sharing protocol can be opportunistic by providing a downlink notification at a time of low congestion.

In certain other embodiments, it may be possible to revise a TPR where the eNB transmits a new or subsequent TPR, which will provide the UE with an updated plan based on updated congestion information at the eNB, for example. Additional repetition of TPR may be used during a low congestion period on the link. The network knowledge sharing message may use an additional field, such as a TPR confirmation when the UE plans to use a transfer plan.

In certain embodiments, the knowledge sharing protocol may impact the handoff and/or load-balancing decisions of the network. For example, if the eNB knows of a large transfer, then the eNB may preferentially handoff the subscriber to a small cell on a different band having a similar load-balancing ratio, in order to enable it to perform a rapid synchronization. In some embodiments, instead of using the messaging over MAC, the messaging may be performed over RRC.

In some embodiments, a retransmission protocol may be associated with the MAC CE messaging or knowledge sharing protocol, in order to increase the reliability with which the knowledge sharing messaging can be received by the UE and/or the eNB. In another embodiment, the downlink knowledge sharing message may be repeated more frequently and/or more quickly, when the current network congestion on a link is relatively low. For example, if there is a particularly ideal time for a transfer, then the network entity may preemptively repeat the downlink knowledge sharing notification to the UE in order to guard against the scenario where one of the two messages is lost. This embodiment may protect against the MAC messaging not being completely reliable. MAC UE may, in certain embodiments, utilize a hybrid automatic repeat request (HARQ).

In some embodiments, messaging can be repeated more when the congestion within the cell is less. In this embodiment, the eNB congestion on that link may indicate that the cost associated with the knowledge sharing messaging is smaller, such that greater preemptive repeating of that knowledge sharing messaging can be used.

In other embodiments, the UE may automatically be allowed to perform more repetition of its knowledge sharing messaging when it has been informed that the uplink is relatively uncongested. Conversely, the UE may be automatically prohibited from performing as much repetition of its knowledge sharing messaging, when the UE has been informed that the uplink is relatively congested.

The network may track a KPI metric, in certain embodiments, corresponding to the degree to which the UE subscriber network utilization adheres to the guidance from the knowledge sharing protocol. For example, the network may determine that knowledge sharing protocol UEs from a first vendor do a particularly good job of adjusting their traffic to utilize non-congested opportunities within the network. The network may further determine that when UE subscribers from this first vendor indicate that they do or do not need to be connected mode, that these preferences are relatively good indications of what is efficient from a radiofrequency (RF) capacity perspective. In contrast, a UE subscriber from a second vendor may do a poorer job of responding to the knowledge sharing protocol, for example, generating a relatively large fraction of bytes in the most congested cells.

In response to this network KPI determination, the network may determine to reduce the amount of knowledge sharing protocol support for the knowledge sharing protocol UEs from the second vendor, commensurate with the lower amount of benefit generated from supporting the knowledge sharing protocol with respect to the UEs from the second vendor.

In certain embodiments, the knowledge sharing protocol may support exchanges with respect to multiple transfers from a single UE, where each transfer may have different transfer attributes. The multiple transfers may run in parallel with one another. Each transfer may have a unique identifier, such as a sequence number or an index. The subscriber device, for example, a UE, may select the initial identifier to identify the transfer. Subsequently, the eNB can use the same identifier to provide feedback with respect to that transfer, such as recommending a particular time in which to perform the transfer.

In some embodiments, a background transfer may be referred to as a non-priority transfer. The network knowledge sharing protocol context may also include the information on what version of the protocol is supported. In other embodiments, turning off the support of the network knowledge sharing protocol may include determining to change the cell ID descriptor or attributes, such that UEs will no longer identify that cell as being the cell which previously supported the network knowledge sharing protocol.

In a further embodiment, a transfer size may be conveyed not in units of bytes, but rather relative to the anticipated number of physical resource blocks expected to be consumed. This may be utilized, for example, when the subscriber anticipates its mobility within the cell, and that its signal strength, for example, RSRP or RSRQ, will change between now and when the transfer is planned. Rather than having the subscriber device try to convey the change, signal strength, and the anticipated number of bytes, the device can simply convey an anticipated number of physical resource blocks associated with that transfer.

The network entity, for example eNB, may make use a long-term scheduler, in some embodiments. The long-term scheduler can use the average cell congestion, the application anticipated transfers or BSRs, and/or other transfer reports. The long-term scheduler can then estimate the future congestion and generate the downlink messaging associated with the determination of the long-term scheduler.

In another embodiment, the eNB may estimate the likelihood that the congestion on a link will improve by comparing the shorter-term congestion over time window, having a duration W, with the congestion over a longer time window being equal to (4*W). If the congestion in the longer time window is lower than in the short duration, then the eNB may further utilize this as a factor in determining that the congestion is likely to improve. Additionally, if each of the previous four consecutive windows had progressively lower congestion, then the eNB may further utilize this as a factor in determining that the congestion is more likely to improve or decrease.

In order to avoid conflict in the communication system, in certain embodiments, neither the UE nor the network entity, for example eNB, should transmit a knowledge sharing message (MAC CE on a reserved index) unless the transmitter knows that the receiver supports the knowledge sharing. If there is a new connection or a handoff, the eNB does not transmit a knowledge sharing message until the eNB verifies that the UE has knowledge sharing, for example the eNB checks IMEISV. In other embodiments, the UE cannot transmit a knowledge sharing message until the UE verifies the eNB has sent a knowledge sharing message.

In certain other embodiments, if a currently reserved MAC CE index is defined in a later LTE release, then that new MAC CE index should not be transmitted by the eNB, or another network entity, to earlier released UEs. The eNB may transmit a new MAC CE index only to a new LTE release UE, such as from RRC UE Capabilities. This can prevent previously released knowledge sharing UEs from receiving the new MAC CE index. UEs for the new LTE release can also use knowledge sharing with an updated index set for that LTE release. In some embodiments, the eNB may know of the UE release, from UE capabilities in RRC, so the eNB can use the appropriate knowledge sharing protocol index set for UEs from that LTE release.

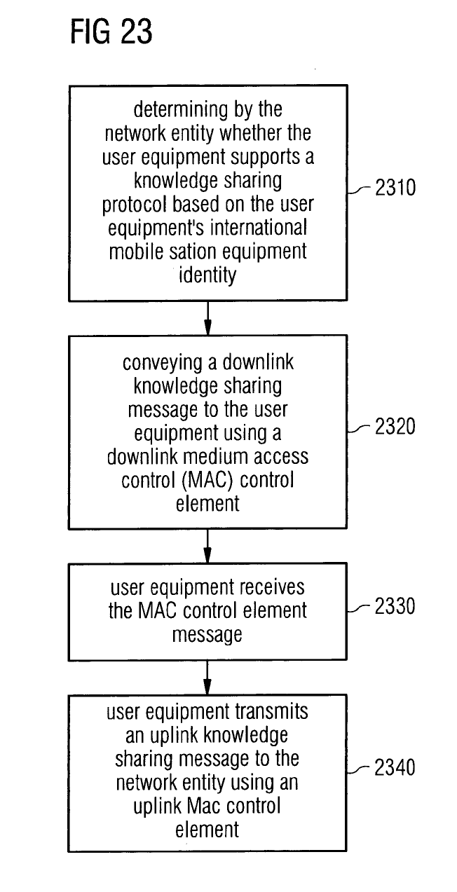

FIG. 23 illustrates a flow diagram according to certain embodiments. Specifically, FIG. 23 may illustrate a method of enabling a knowledge sharing between a UE and a network entity in a cellular network. In step 2310, when a new connection, or a handoff is detected, the network entity, for example eNB, may determine whether the UE supports knowledge sharing based on the user equipment's international mobile station equipment identity (IMEISV). In response to this determination, the eNB may convey downlink knowledge sharing message to a UE using a downlink MAC CE, the MAC CE having in certain embodiments currently reserved index, as shown in step 2320. The UE may then receive this MAC CE reserved index message, as shown in step 2330. The IMEISV may have a terminal type and/or a software version. In addition, the IMEISV may unambiguously indicate knowledge sharing support. The masked IMEISV may also avoid identifying individual mobile equipment.

Further, the method may include that in response to receiving a downlink knowledge sharing message, the UE can transmit uplink knowledge sharing message to the eNB using an uplink MAC CE with currently reserved index, as shown in step 2340. The UE, in certain embodiments, may not be able to transmit knowledge sharing message unless the UE has received a knowledge sharing message from the eNB. The UE indication over this protocol may additionally indicate the UEs mobility plans, such that if the UE goes idle, and it previously indicates that it was going to stay static, then an indication of the network can be provided, for example to the MME, to indicate that this particular UE is likely still on the same cell, and is waiting for a low congestion indication.

The UE may use its anticipated mobility and/or anticipated signal strength to calculate the maximum signal strength interval where a transfer could occur. The UE may then further communicate over the knowledge sharing protocol the time of this anticipated transfer.

In certain embodiments, a method may be provided for using a special protocol. The network may use knowledge of the UE transfers indicated over the special protocol, to better estimate future congestion for usage in performing load-balancing, admission control, and impacting handoff decisions. The UE reports about potential or anticipated transfers may be conveyed over application anticipated BSR, or informational BSRs. The network entity, for example an eNB, may additionally indicate the vendor type over this protocol.

In other embodiments, connected DRX may be used to allow subscribers to save battery life while staying in connected mode, and while waiting for an opportunistic notification of a low congestion event. The network entity may also indicate to the UE what RRC inactivity timer value is currently planned to be used by the network for that UE. The network, in certain embodiments, can automatically adjust the timescale of the network utilization provided to the UE, based on the size and/or timescale of the anticipated transfer indicated by the device. The UE may in certain embodiments manually reset the inactivity by generating traffic, instead of generating a channel preference request message.

Embodiments of the present disclosure may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. A non-transitory computer-readable medium may be any media or means that can contain, store, communicate, propagate, or transport the instructions for use by or in connection with an instruction execution system, apparatus, or device, such as a computer. A non-transitory computer-readable medium may comprise a computer-readable storage medium, for example memory or other device, that may be any media or means that can contain or store the instructions for use by or in connection with an instruction execution system, apparatus, or device, such as a computer.

As such, certain embodiments may include a computer program product comprising a computer-readable storage medium bearing computer program code embodied therein for use with a computer, the computer program code comprising code for performing any of the methods and variations thereof as previously described. Further, certain embodiments may also include an apparatus which comprises one or more processors, and one or more memories including computer program code, wherein the one or more memories and the computer program code are configured, with the one or more processors, to cause the apparatus to perform any of the methods and variations thereof as previously described.

The different functions discussed above may be performed in a different order and/or concurrently with each other. Furthermore, if desired, one or more of the above-described functions may be optional or may be combined. While exemplary embodiments of the disclosure are discussed above, these descriptions should not be viewed in a limiting sense. Rather, there are several variations and modifications which may be made without departing from the scope of the present disclosure.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the disclosure.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

Partial Glossary

3GPP Third Generation Partnership Project

CDMA Code Division Multiple Access

CAN Content Aware Network

CAN-EG Content Aware Network—Enabling Gateway

CDN Content Distribution Network

C-SON Centralized Self Optimizing Network

DL Downlink

E-UTRA Evolved Universal Terrestrial Radio Access

eNB or eNodeB Evolved Node B/Base Station in an E-UTRAN System

EPC Enhanced Packet Core

E-UTRAN Evolved UTRAN (LTE)

FDD Frequency Division Duplex

FDM Frequency Division Multiplexing

GPS Global Positioning System

GSM Global System for Mobile Communications

GPRS General Packet Radio Service

GTP GPRS tunneling protocol

HetNET Heterogeneous Network

HO Handoff

IP Internet Protocol

IRP Interface Reference Point

LTE Long Term Evolution

LTE-A Long Term Evolution Advanced

MAC Medium Access Control

MDT Minimization of Drive Tests

MME Mobility Management Entity

MO Media Optimizer

MR Measurement Report

PCRF Policy and Charging Rule Function

PDN-GW Packet Data Network Gateway

QAM Quadrature Amplitude Modulation

QPSK Quadrature (Quaternary) Phase Shift Keying

RRC Radio Resource Control

RAN Radio Access Network

RF Radio Frequency

Rx Reception

SGW Serving Gateway

SON Self-Optimizing Network

TDD Time Division Duplex

TDM Time Division Multiplexing

Tx Transmittance

UCI Uplink Control Information

UE User Equipment (e.g. mobile terminal)

UL Uplink

UMTS Universal Mobile Telecommunications System

UTRAN Universal Terrestrial Radio Access Network

1.-35. (canceled)

36. A method, comprising:
analyzing, at a network entity, conditions affecting a user equipment receiving data from a data communication network;
determining whether the user equipment should perform an action relating to data delivery based on the conditions; and
sending information from the network entity to the user equipment indicating when the user equipment should perform the action.

37. A method according to claim 36, wherein the conditions are at least one of present, predicted, estimated, or future conditions.

38. The method according to claim 36, wherein the data is video data.

39. The method according to claim 38, wherein the data is delivered before the data is needed for playback.

40. The method according to claim 36, wherein delivery of the data is maintained so that the data is available during slow or interrupted service.

41. The method according to claim 36, wherein at least one self-optimizing network function predicts a service degradation or a service improvement as the condition affecting the user equipment.

42. The method according to claim 36, wherein the condition is a likelihood that the user equipment will abandon the data or will encounter degraded service.

43. The method according to claim 36, wherein the sending of the message to the user equipment is performed according to a notification policy, and wherein the notification policy is defined by at least one self-optimized network function.

44. The method according to claim 43, wherein the notification policy defines at least one of a specific event type, a performance of at least one action based on at least one target, at least one key performance indicator, at least one threshold, or at least one control.

45. The method according to claim 43, wherein the notification policy designates at least one user equipment group including the user equipment.

46. The method according to claim 36, wherein the information is sent to the user equipment as an air interface signal, a radio resource control message, or a media access control message.

47. The method according to claim 36, wherein the information is sent in an application layer or a network layer.

48. The method according to claim 36, wherein the network entity uses an application for sending the information.

49. The method according to claim 36, wherein the information comprises an indication that an air interface of the user equipment is expected to become impaired, and wherein the indication includes an estimated time until the impairment.

50. The method according to claim 36, further comprising:
selecting the user equipment to receive the information based on a level of service to which the user equipment is entitled.

51. The method according to claim 36, wherein the condition comprises an anticipated quality of service degradation or anticipated handover.

52. A method, comprising:
receiving information at a user equipment from a network entity based on a condition affecting the user equipment, wherein the information indicates that the user equipment perform an action related to data delivery; and
performing the action based on the received information while the condition is affecting the user equipment.

53. The method according to claim 52, further comprising:
requesting the network entity to deliver the data for pre-filling based on the information; and
requesting the network entity to maintain delivery of the data before it is needed.

54. The method according to claim 52, further comprising:
requesting an increase in data compression in response to the received information;
wherein the information comprises an indication of favorable conditions or a prediction of degradation of channel conditions.

55. An apparatus, comprising:
at least one processor; and
at least one memory including computer program code,
wherein the at least one memory and the computer program code are configured to, with the at least one processor, cause the apparatus at least to:
analyze, at a network entity, conditions affecting a user equipment receiving data from a data communication network;
determine whether the user equipment should perform an action relating to data delivery based on the conditions; and
send information from the network entity to the user equipment indicating when the user equipment should perform the action.
